(19) United States
(12) Patent Application Publication
(10) Pub. No.: US 2026/0008702 A1
(43) Pub. Date: Jan. 8, 2026

(54) CATALYST FOR DECOMPOSING ORGANIC MATTER AND SYSTEM FOR DECOMPOSING ORGANIC MATTER COMPRISING THE SAME

(71) Applicant: University-Industry Cooperation Group of Kyung Hee University, Yongin-si (KR)

(72) Inventor: Jongsik KIM, Yongin-si (KR)

(21) Appl. No.: 19/070,409

(22) Filed: Mar. 4, 2025

(30) Foreign Application Priority Data
Jul. 2, 2024 (KR) 10-2024-0087023
Oct. 11, 2024 (KR) 10-2024-0138528

(51) Int. Cl. C02F 1/461; C02F 1/467; C02F 101/34; C02F 101/38

(52) U.S. Cl. CPC C02F 1/46109; C02F 1/4672; C02F 2001/46142; C02F 2001/46161; C02F 2101/345; C02F 2101/38; C02F 2305/023

(57) ABSTRACT

Embodiments relate to a catalyst for decomposing organic substances and a system for decomposing organic substances including the same, and specifically, to an electrical or non-electrical organic substance decomposition system for efficient decomposition of toxic or recalcitrant organic substances, including: 1) at least one of the following four types of transition metal oxide particles: non-reducible transition metal oxide particles, surface-reduced non-reducible transition metal oxide particles, non-reducible transition metal oxide particles containing at least one of NO₃⁻, H_{3-A}PO₄^{A-} (A=1-3), and SO₄²⁻ functional groups, and surface-reduced non-reducible transition metal oxide particles containing at least one of NO₃⁻, H_{3-A}PO₄^{A-} (A=1-3), and SO₄²⁻ functional groups; and 2) an aqueous electrolyte solution having a pH of less than 2 and containing an acid.

### CROSS REFERENCE TO RELATED APPLICATION

The present application claims priority to Korean Patent Application No. 10-2024-0087023, filed Jul. 2, 2024, and Korean Patent Application No. 10-2024-0138528 filed Oct. 11, 2024, the entire contents of which are incorporated here for all purposes by this reference.

### BACKGROUND

### 1. Technical Field

The present disclosure relates to a system for efficient decomposition of toxic or recalcitrant organic substances under electrical or non-electrical conditions, which includes the following components. Specifically, the system of the present disclosure includes: 1) a catalyst including at least one of the following four types of transition metal oxide particles: non-reducible transition metal oxide particles, surface-reduced non-reducible transition metal oxide particles, non-reducible transition metal oxide particles containing at least one of NO₃⁻, H_{3-A}PO₄^{A-} (A=1-3), and SO₄²⁻ functional groups, and surface-reduced non-reducible transition metal oxide particles containing at least one of NO₃⁻, H_{3-A}PO₄^{A-} (A=1-3), and SO₄²⁻ functional groups; and 2) an acidic aqueous solution having a pH of less than 2 and containing at least one of nitric acid (HNO₃), phosphoric acid (H₃PO₄), sulfuric acid (H₂SO₄) or hydrochloric acid (HCl). In addition, specifically, the non-electrical conditions in the present disclosure are characterized by including hydrogen peroxide (H₂O₂) or ozone (O₃), which is a precursor of ·OH radicals, and in that the catalyst particles are dispersed in powder form in an aqueous solution, or the catalyst particles are supported on a support, and the support is immersed in an acidic aqueous solution in a state in which a substrate is coated with the support. In addition, specifically, the electrical conditions in the present disclosure are characterized in that the catalyst particles are supported on a support, the support is immersed in an aqueous solution in a state in which a substrate is coated with the support, and hydrogen peroxide, a precursor of ·OH radicals, is produced in the aqueous solution, or the aqueous solution contains ozone.

### 2. Related Art

One of technologies for mineralization (conversion into H₂O/CO/CO₂, etc.) of wastewater containing toxic or recalcitrant organic substances such as phenols, environmental hormones, residual pharmaceuticals, pesticides, and special chemicals (water used for treatment of semiconductor and secondary battery materials) is the advanced oxidation process (AOP), which oxidizes and decomposes the organic substances contained in wastewater by generating radicals (e.g., ·OH) with a high standard oxidation potential in the water. One of the representative AOPs is a non-electrical degradation process that converts a radical precursor into a radical in the presence of a catalyst and oxidizes and decomposes organic substances using the radical. Another representative AOP is an electrical decomposition process that oxidizes and decomposes organic substances by applying voltage between an anode not coated with a catalyst and a cathode coated with a catalyst.

The electrical decomposition process offers two major advantages over the non-electrical decomposition process. That is, 1) a large amount of hydrogen peroxide (H₂O₂) can be supplied by oxygen reduction (2H⁺+O₂+2e⁻→H₂O₂) occurring at the cathode, and 2) a significant amount of ·OH can be supplied by the heterogeneous catalysis-based heterolysis of hydrogen peroxide (H₂O₂) (H₂O₂→OH⁻+·OH+e⁻; e⁻: electron) or the homolysis of hydrogen peroxide (H₂O₂) (H₂O₂→·OH+·OH), which occurs on the surface of a transition metal oxide catalyst with which the cathode is coated.

On the other hand, in the electrical decomposition process, when the cathode is coated with a reducible transition metal oxide (e.g., MnO₂, Fe₂O₃, Co₂O₃, NiO or CuO) is coated and Mn⁴⁺, Fe³⁺, Co³⁺, Ni²⁺ or Cu²⁺ (hereinafter referred to as Mⁿ⁺) existing on the surface of the reducible transition metal oxide is used as active surface species, hydrogen peroxide (H₂O₂) undergoes heterolysis to generate ·OH and M⁽ⁿ⁺¹⁾⁺ (H₂O₂+Mⁿ⁺→OH⁻+·OH+M⁽ⁿ⁺¹⁾⁺). The generated M⁽ⁿ⁺¹⁾⁺ is reduced to Mⁿ⁺ (e− reduction: M⁽ⁿ⁺¹⁾⁺+e⁻→Mⁿ⁺) by the abundant electrons (e⁻) in the reaction solution and may be reused for heterolysis of hydrogen peroxide. On the other hand, in the electrical decomposition process, when the cathode is coated with a non-reducible transition metal oxide (e.g., TiO₂, ZrO₂, HfO₂, Nb₂O₅ or Ta₂O₅) and Ti⁴⁺, Zr⁴⁺, Hf⁴⁺, Nb⁵⁺ or Ta⁵⁺ (hereinafter referred to as Mⁿ⁺) present on the non-reducible transition metal oxide is used as active surface species, hydrogen peroxide (H₂O₂) undergoes homolysis to generate ·OH, but does not involve oxidation of Mⁿ⁺ (generation of M⁽ⁿ⁺¹⁾⁺) (H₂O₂+Mⁿ⁺→·OH+·OH+Mⁿ⁺).

Non-reducible transition metal oxide surface-active species may provide the three advantages described below for hydrogen peroxide dissociation compared to reducible transition metal oxide surface-active species. That is, 1) the non-reducible transition metal oxide surface-active species can cause homolysis of hydrogen peroxide (H₂O₂→2·OH), which can double the production (amount) of ·OH compared to heterolysis of hydrogen peroxide (H₂O₂→OH⁻+·OH), 2) the oxidation state of Mⁿ⁺ (e.g., Ti⁴⁺, Zr⁴⁺, Nb⁵⁺, Ta⁵⁺) does not change even after homolysis of hydrogen peroxide, and thus electron reduction (e-reduction) to continuously cause homolysis of hydrogen peroxide is unnecessary, and 3) unlike the surface-active species for heterolysis of hydrogen peroxide, with which the cathode is coated, the surface-active species for homolysis of hydrogen peroxide, with which the cathode is coated, avoids continuous and serious leaching, thereby significantly increasing the number of uses of the coated catalyst.

In the case of TiO₂, which belongs to the family of non-reducible transition metal oxides, the band gap energy may be reduced to less than 3.0 eV by hydrogen (H₂) reduction, and thus TiO₂ can generate holes in the valence band and locate electrons (e⁻) in the conduction band under visible light/ultraviolet light (TiO₂+hv (visible light/ultraviolet light)→h_{VB}⁺+e_{CB}⁻; VB: valence band; h: hole; CB: conduction band). That is, the reduced TiO₂, May 1) may convert H₂O or OH⁻ into ·OH, O₂·⁻ and ¹O₂ by a semiconducting mechanism under visible light/ultraviolet light, or 2) may form a composite with a substance (including Mⁿ⁺) that causes heterolysis of hydrogen peroxide (H₂O₂+Mⁿ⁺→OH⁻+·OH+M⁽ⁿ⁺¹⁾⁺), and then electrons (e⁻) located in the conduction band can easily reduce M⁽ⁿ⁺¹⁾⁺, formed after heterolysis of hydrogen peroxide, by a heterojunction mechanism under visible light/ultraviolet light, thereby increasing ·OH production. Nevertheless, there are few examples in which reduced TiO₂ was used as a catalyst for the activation of hydrogen peroxide homolysis (H₂O₂→2·OH) in the absence of visible light/UV light.

In addition, as shown in Table 1 below, ·OH has a very short half-life despite providing a high standard oxidation potential compared to NO₃·, H₂PO₄·, HPO₄·⁻, PO₄²·⁻ (hereinafter referred to as H_{3-A}PO₄^{(A-1)}·⁻; A=1-3), SO4·⁻ or Cl·, and thus the organic substance decomposition efficiency thereof organic may not be remarkable compared to NO₃·, H_{3-A}PO₄^{(A-1)}·⁻, SO₄·⁻ or Cl·. In addition, despite having a slightly lower standard oxidation potential and considerably longer half-life than ·OH, NO₃·, H_{3-A}PO₄^{(A-1)}·⁻, SO₄·⁻ or Cl·, it may not be easily used for the decomposition of organic substances because it is produced in a limited manner in the presence of ultraviolet light or in the presence of radioactive elements.

TABLE 1

| Radicals | ^{•}OH | NO₃^{•} | H₂PO₄^{•} | HPO₄^{•-} | PO₄^{2•-} | SO₄^{•-} | Cl^{•} |
|---|---|---|---|---|---|---|---|
| Standard | 2.7 | 2.3 | 2.4 | 2.4 | 2.4 | 2.6 | 2.6 |
| oxidation | | | | | | | |
| potential | | | | | | | |
| (V) | | | | | | | |
| Half-life | 10⁻³ | 60 | 100 | 100 | 100 | 10¹-10₂ | 10⁰-10¹ |
| (×10⁻⁶ | | | | | | | |
| sec) | | | | | | | |

Importantly, the properties of Lewis acid species (e.g., Ti⁴⁺, Zr⁴⁺, Hf⁴⁺, Nb⁵⁺ or Ta⁵⁺) and Brønsted acid species (—OH) existing on non-reducible transition metal oxides (e.g., TiO₂, ZrO₂, HfO₂, Nb₂O₅ or Ta₂O₅) can exhibit improved activity (·OH productivity) in hydrogen peroxide homolysis when the surface of the non-reducible transition metal oxides is reduced with hydrogen.

Also, importantly, the surface of the non-reducible transition metal oxides or the surface-reduced non-reducible transition metal oxides may be functionalized with NO₃⁻, H_{3-A}PO₄^{A-} or SO₄²⁻, which is a precursor of NO₃·, H_{3-A}PO₄^{(A-1)}·⁻ or SO₄·⁻. (Surface-reduced) non-reducible transition metal oxides functionalized with NO₃⁻, H_{3-A}PO₄^{A-} or SO₄²⁻ can exhibit enhanced hydrogen peroxide homolytic activity (·OH productivity) compared to non-functionalized (surface reduced) non-reducible transition metal oxides, and generate NO₃·(·OH+NO₃⁻ (catalyst surface)→OH⁻+NO₃·(catalyst surface), H_{3-A}PO₄^{(A-1)}·⁻ (·OH+H_{3-A}PO₄^{A-} (catalyst surface)→OH⁻+H_{3-A}PO₄^{(A-1)}·⁻ (catalyst surface) or SO₄·⁻ (·OH+SO₄²⁻ (catalyst surface)→OH⁻+SO₄·⁻ (catalyst surface), immobilized on the non-reducible transition metal oxide surface, via a radical transfer mechanism, thereby exhibiting enhanced organic substance decomposition efficacy compared to ·OH.

Nevertheless, there is no report on an organic substance decomposition system that provides 1) aqueous ·OH (hereinafter referred to as ·OH (aq)), 2) NO₃·(hereinafter referred to as NO₃·(catalyst surface)), H_{3-A}PO₄^{(A-1)}·⁻ (hereinafter referred to as H_{3-A}PO₄^{(A-1)}·⁻ (catalyst surface)) or SO₄·⁻ (hereinafter referred to as SO₄·⁻ (catalyst surface)) immobilized on the oxide surface, and 3) aqueous NO₃·(hereinafter referred to as NO₃·(aq)), aqueous H_{3-A}PO₄^{(A-1)}·⁻ (hereinafter referred to as H_{3-A}PO₄^{(A-1)}·⁻ (aq)), aqueous SO₄·⁻ (hereinafter referred to as SO₄·⁻ (aq)) or aqueous Cl·(hereinafter referred to as Cl·(aq)) using (surface-reduced) non-reducible transition metal oxides or (surface-reduced) non-reducible transition metal oxides functionalized with NO₃⁻, H_{3-A}PO₄^{A-} or SO₄²⁻, which avoid leaching of surface active species, in an aqueous solution rich in hydrogen peroxide (or ozone) while avoiding the above-described harsh conditions (absence of ultraviolet light and radioactive elements).

### SUMMARY

The present disclosure has been made in order to solve the above-described problems occurring under electrical or non-electrical conditions, and an object of the present disclosure is to provide a system that produces 1) ·OH (aq) through hydrogen peroxide homolysis, or 2) NO₃·(catalyst surface), 3) H_{3-A}PO₄^{(A-1)}·⁻ (catalyst surface) or 4) SO₄·⁻ (catalyst surface) through a radical transfer mechanism using as a catalyst at least one of non-reducible transition metal oxides, surface-reduced non-reducible transition metal oxides, non-reducible transition metal oxides functionalized with NO₃⁻, H_{3-A}PO₄^{A-} or SO₄²⁻, or surface-reduced non-reducible transition metal oxides functionalized with NO₃⁻, H_{3-A}PO₄^{A-} or SO₄²⁻, which are capable of avoiding leaching of active species and in which highly dispersed Brønsted acid active species and Lewis acid active species, which are active species for hydrogen peroxide homolysis, are highly dispersed.

Another object of the present disclosure is to provide a system that produces with high efficiency 5) aqueous NO₃·(hereinafter referred to as NO₃·(aq); ·OH+NO₃⁻ (aq)→OH⁻+NO₃·(aq) or ·OH+HNO₃ (aq)→H₂O+NO₃·(aq)), 6) aqueous H_{3-A}PO₄^{(A-1)}·⁻ (hereinafter referred to as H_{3-A}PO₄^{(A-1)}·⁻ (aq); ·OH+H_{3-A}PO₄^{A-} (aq)→OH⁻+H_{3-A}PO₄^{(A-1)}·⁻ (aq)), 7) aqueous SO₄·⁻ (hereinafter referred to as SO₄·⁻ (aq); ·OH+SO₄²⁻ (aq)→OH⁻+SO₄·⁻ (aq) or 2·OH+H₂SO₄ (aq)→2H₂O+2SO₄·⁻ (aq)), or 8) aqueous Cl·(hereinafter referred to as Cl·(aq); ·OH+Cl⁻ (aq)→OH⁻+Cl·(aq) or ·OH+HCl (aq)→H₂O+Cl·(aq)) through a radical transfer mechanism using as a catalyst an acidic aqueous solution having a pH of less than 2 and containing at least one of nitric acid (HNO₃), phosphoric acid (H₃PO₄), sulfuric acid (H₂SO₄) or hydrochloric acid (HCl).

Still another object of the present disclosure is to provide a system that dramatically improve the efficiency of decomposition of recalcitrant/toxic organic substances by generating at least one of the radicals of 2) to 8) other than ·OH (aq), that is, NO₃·(catalyst surface), H_{3-A}PO₄^{(A-1)}·⁻ (catalyst surface), SO₄·⁻ (catalyst surface), NO₃·(aq), H_{3-A}PO₄^{(A-1)}·⁻ (aq), SO₄·⁻ (aq) or Cl·(aq), with high efficiency.

Ultimately, an object of the present disclosure is to provide a catalyst for electrical/non-electrical generation of radicals and a recalcitrant/toxic organic substance decomposition reaction system using the above-described six types of radicals, which can solve problems such as low organic substance decomposition reaction rate/efficiency and serious leaching of surface active sites, which have been pointed out as shortcomings of existing electrical/non-electrical organic substance decomposition systems. The objects to be achieved by the present disclosure are not limited to the objects mentioned above, and other objects not mentioned may be clearly understood by those skilled in the art from the following description.

To achieve the above-described objects, one aspect of the present disclosure provides a catalyst for an organic substance decomposition system, including catalyst particles including a non-reducible transition metal oxide.

At least a portion of the surface of the non-reducible transition metal oxide may be a reduced surface.

At least a portion of the surface of the non-reducible transition metal oxide may include a functional group.

The functional group may include at least one selected from the group consisting of a nitrate group, a phosphate group, a sulfate group, and combinations thereof.

The nitrate group may include NO³⁻, the phosphate group may include at least one selected from the group consisting of H₂PO₄⁻, HPO₄²⁻, PO₄³⁻, and combinations thereof, and the sulfate group may include SO₄²⁻.

The non-reducible transition metal oxide may include at least one selected from the group consisting of TiO₂, ZrO₂, HfO₂, Nb₂O₅, Ta₂O₅, and combinations thereof.

The catalyst may have a porous structure.

The catalyst may have a diameter of 0.1 nm to 500 μm.

Another aspect of the present disclosure provides a method for producing a catalyst for an organic substance decomposition system, including a production step of producing catalyst particles including a non-reducible transition metal oxide.

The production method may further include a reduction step of reducing at least a portion of the surface of the catalyst particles by treatment with hydrogen.

The production method may further include a functionalization step of attaching a functional group to at least a portion of the surface of the catalyst particles.

Still another aspect of the present disclosure provides an electrode for an organic substance decomposition system, including: the above-described catalyst; a support on which the catalyst is supported; a substrate coated with the support; and a binder interposed between the support and the substrate.

The catalyst may be in powder form.

The catalyst may be included in an amount of 0.01 to 50 parts by weight based on 100 parts by weight of the support.

The support may include at least one selected from the group consisting of carbon (C), Al₂O₃, MgO, ZrO₂, CeO₂, SiO₂, and combinations thereof.

The binder may be an insoluble polymer.

Yet another aspect of the present disclosure provides an organic substance decomposition system including: the above-described electrode; and an aqueous electrolyte solution containing at least one acid selected from the group consisting of nitric acid (HNO₃), phosphoric acid (H₃PO₄), sulfuric acid (H₂SO₄), hydrochloric acid (HCl), and combinations thereof.

The aqueous electrolyte solution may contain a supporting electrolyte, wherein the concentration of the supporting electrolyte may be 10⁻⁵ mol L⁻¹ to 10⁵ mol L⁻¹.

The pH of the electrolyte solution may be less than 2.

The system may be used in a process of decomposing organic substances under electrical or non-electrical conditions.

Still yet another aspect of the present disclosure provides a method for decomposing organic substances using an organic substance decomposition system, including: a step in which aqueous ·OH species is formed by homolysis of H₂O₂; a step in which functionalized NO₃⁻ surface species, H₂PO₄⁻/HPO₄²⁻/PO₄³⁻ surface species or SO₄²⁻ surface species is converted into NO₃·surface species, H₂PO₄·/HPO₄·⁻/PO₄²·⁻ surface species or SO₄·⁻ surface species by the aqueous ·OH species; a step in which aqueous NO₃⁻, aqueous PO₄³⁻, aqueous SO₄²⁻ or aqueous Cl⁻ is converted into aqueous NO₃·, aqueous H₂PO₄·/HPO₄·⁻/PO₄²·⁻, aqueous SO₄·⁻ or aqueous Cl·by the aqueous ·OH species; and a step in which recalcitrant/toxic organic substances are decomposed by at least one radical species among the aqueous ·OH, the NO₃·surface species, the H₂PO₄·/HPO₄·⁻/PO₄²·⁻ surface species, the SO₄·⁻ surface species, the aqueous NO₃⁻, the aqueous H₂PO₄·/HPO₄·⁻/PO₄²·⁻, the aqueous SO₄·⁻ and the aqueous Cl·.

According to an embodiment of the present disclosure, the proposed catalysts may be applied to the oxidative decomposition of wastewater, phenols, environmental hormones, residual pharmaceuticals, pesticides, and special chemicals (e.g., water used for treatment of semiconductor and secondary battery materials).

In addition, according to one embodiment of the present disclosure, an organic substance decomposition system into which a ZrO₂ or TiO₂-based catalyst has been introduced may increase at least one of ·OH productivity, aqueous NO₃·productivity or aqueous Cl·productivity compared to an organic substance decomposition system into which the ZrO₂ or TiO₂-based catalyst has not been introduced, and thus the organic substance decomposition system into which the ZrO₂ or TiO₂-based catalyst has been introduced may dramatically increase the efficiency of decomposition of recalcitrant/toxic organic substances compared to the organic substance decomposition system into which the ZrO₂ or TiO₂-based catalyst has not been introduced has not been introduced.

In addition, according to one embodiment of the present disclosure, an organic substance decomposition system into which a supporting electrolyte (e.g., Na₂SO₄) and a ZrO₂ catalyst have been introduced may increase at least one of ·OH productivity, aqueous NO₃·productivity or aqueous Cl·productivity compared to an organic substance decomposition system into which only the ZrO₂ catalyst has been introduced, and thus the organic substance decomposition system into which the supporting electrolyte and the ZrO₂ catalyst have been introduced may dramatically increase the efficiency of decomposition of recalcitrant/toxic organic substances compared to the organic substance decomposition system into which only the ZrO₂ catalyst has been introduced.

In addition, according to one embodiment of the present disclosure, an organic substance decomposition system into which a surface-reduced TiO₂ catalyst has been introduced may increase at least one of ·OH productivity, aqueous NO₃·productivity or aqueous Cl·productivity compared to an organic substance decomposition system into which a non-surface-reduced TiO₂ catalyst has been introduced, and thus, the organic substance decomposition system into which the surface-reduced TiO₂ catalyst has been introduced may dramatically increase the efficiency of decomposition of recalcitrant/toxic organic substances compared to the organic substance decomposition system into which a non-surface-reduced TiO₂ catalyst has been introduced.

In addition, according to one embodiment of the present disclosure, an organic substance decomposition system into which a TiO2 catalyst including NO₃⁻ surface species, H₂PO₄⁻/HPO₄²⁻/PO₄³⁻ surface species or SO₄²⁻ surface species has been introduced may increase at least one of ·OH productivity, aqueous NO₃·productivity or aqueous Cl·productivity compared to an organic substance decomposition system into which a TiO₂ catalyst not including NO₃⁻ surface species, H₂PO₄⁻/HPO₄²⁻/PO₄³⁻ surface species or SO₄²⁻ surface species has been introduced, and may additionally provide NO₃·surface species, H₂PO₄·/HPO₄·⁻/PO₄²·⁻ surface species or SO₄·⁻ surface species. Accordingly, the organic substance decomposition system into which the TiO₂ catalyst including NO₃⁻ surface species, H₂PO₄⁻/HPO₄²⁻/PO₄³⁻ surface species or SO₄²⁻ surface species has been introduced may dramatically increase the efficiency of decomposition of recalcitrant/toxic organic substances compared to the organic substance decomposition system into which the TiO₂ catalyst not including NO₃⁻ surface species, H₂PO₄⁻/HPO₄²⁻/PO₄³⁻ surface species or SO₄²⁻ surface species has been introduced.

In addition, according to one embodiment of the present disclosure, it is possible to almost completely avoid leaching of catalyst particles that occurs during decomposition of recalcitrant/toxic organic substances, and thus the organic substance decomposition performance may be maintained during multiple system operations, and there is an effect of improving the catalyst life.

The effects of the present disclosure are not limited to the above-mentioned effects, and it is to be understood that the effects of the present disclosure include all effects that may be deduced from the configuration of the present disclosure described in the description of the present disclosure and the appended claims.

### BRIEF DESCRIPTION OF THE DRAWINGS

FIG. 1 is a scanning electron microscopy (SEM) image of catalysts synthesized according to embodiments of the present disclosure.

FIG. 2 depicts graphs showing the results of X-ray diffraction (XRD) pattern analysis of catalysts synthesized according to embodiments of the present disclosure.

FIG. 3 depicts graphs showing the results of X-ray photoelectron spectroscopy (XPS) for the N 1s, P 2p, and S 2p regions of catalysts synthesized according to embodiments of the present disclosure.

FIGS. 4 to 6 are graphs showing the conversion of acetaminophen decomposed over time under various electrical organic substance decomposition system conditions based on embodiments of the present disclosure.

FIG. 7 depicts graphs showing the results of electron paramagnetic resonance (EPR) spectroscopy in the presence of a catalyst synthesized according to one embodiment of the present disclosure, hydrogen peroxide, a radical trapping agent (5,5-dimethyl-1-pyrroline N-oxide (DMPO)), and various concentrations of aqueous nitric acid solutions.

FIG. 8 is a graph showing the conversion of acetaminophen decomposed over time under electrochemical organic decomposition system conditions in the presence of catalysts synthesized according to embodiments of the present disclosure.

FIG. 9 is a graph showing the conversion of acetaminophen decomposed over time under various non-electrical organic substance decomposition system conditions based on embodiments of the present disclosure.

FIGS. 10 to 11 are graphs showing the conversion of acetaminophen decomposed over time under various electrical organic substance decomposition system conditions based on embodiments of the present disclosure.

FIG. 12 depicts graphs showing the conversion of nitrobenzene decomposed over time under electrical organic substance decomposition system conditions based on an embodiment of the present disclosure.

FIG. 13 depicts graphs showing the results of electron paramagnetic resonance (EPR) spectroscopy in the presence of a catalyst synthesized according to one embodiment of the present disclosure, hydrogen peroxide, a radical trapping agent (5,5-dimethyl-1-pyrroline N-oxide (DMPO)), and various concentrations of aqueous hydrochloric acid solutions.

FIG. 14 is a graph showing the conversion of acetaminophen decomposed over time under electrical organic substance decomposition system conditions in the presence of catalysts synthesized according to embodiments of the present disclosure.

FIG. 15 is a graph showing the conversion of acetaminophen decomposed over time under various non-electrical organic substance decomposition system conditions based on embodiments of the present disclosure.

### DETAILED DESCRIPTION

Hereinafter, the present disclosure will be described in more detail. However, the present disclosure may be embodied in various different forms, and the present disclosure is not limited to the embodiments described herein. The scope of the present disclosure is defined only by the appended claims.

Additionally, the terms used in the present disclosure are only used to describe specific embodiments and are not intended to limit the present disclosure. Singular expressions include plural expressions unless otherwise specified in the context thereof.

Throughout the present specification, it is to be understood that when any part is referred to as “including” any component, it does not exclude other components, but may further include other components, unless otherwise specified.

Throughout the present specification, it is to be understood that, when any part is referred to as being “connected”, “contacted” or “coupled” to another part, it may be “connected directly” to the other part or may be “connected indirectly” to the other part with an intervening element therebetween. In addition, it is to be understood that when any part is referred to as “including” any component, it does not exclude other components, but may further include other components, unless otherwise specified.

The terms used in the present specification are only used to describe specific embodiments and are not intended to limit the present disclosure. Singular expressions include plural expressions unless otherwise specified in the context thereof.

A first aspect of the present disclosure provides a catalyst for an organic substance decomposition system, including catalyst particles including a non-reducible transition metal oxide.

Hereinafter, the catalyst for an organic substance decomposition system according to the first aspect of the present disclosure will be described in detail.

In one embodiment of the present disclosure, at least a portion of the surface of the non-reducible transition metal oxide may be a reduced surface. The reduction may be performed by a method known in the art, and may be performed, for example, by a hydrogen treatment method.

In one embodiment of the present disclosure, as at least a portion of the surface of the non-reducible transition metal oxide is reduced, the non-reducible transition metal oxide may have an effect of increasing at least one of ·OH productivity, aqueous NO₃·productivity, or aqueous Cl·productivity.

In one embodiment of the present disclosure, at least a portion of the surface of the non-reducible transition metal oxide may include a functional group.

In one embodiment of the present disclosure, as at least a portion of the surface of the non-reducible transition metal oxide may include a functional group, the non-reducible transition metal oxide may increase at least one of ·OH productivity, aqueous NO₃·productivity, or aqueous Cl·productivity, and may have an effect of additionally providing NO₃·surface species, H₂PO₄·/HPO₄·⁻/PO₄²·⁻ surface species or SO₄·⁻ surface species.

In one embodiment of the present disclosure, the functional group may include at least one selected from the group consisting of a nitrate group, a phosphate group, a sulfate group, and combinations thereof.

In one embodiment of the present disclosure, the nitrate group may include NO³⁻, the phosphate group may include at least one selected from the group consisting of H₂PO₄⁻, HPO₄²⁻, PO₄³⁻, and combinations thereof, and the sulfate group may include SO₄²⁻.

The non-reducible transition metal oxide may include at least one selected from the group consisting of TiO₂, ZrO₂, HfO₂, Nb₂O₅, Ta₂O₅, and combinations thereof, and may be, for example, ZrO₂ (zirconium dioxide) or TiO₂ (titanium dioxide).

That is, in one embodiment of one aspect of the present disclosure, the catalyst particles may include at least one type selected from the group consisting of non-reducible transition metal oxide catalyst particles, surface-reduced non-reducible transition metal oxide catalyst particles, non-reducible transition metal oxide catalyst particles functionalized with a nitrate group, a phosphate group or a sulfate group, or surface-reduced non-reducible transition metal oxide catalyst particles functionalized with a nitrate group, a phosphate group or a sulfate group, and combinations thereof.

In one embodiment of the present disclosure, the catalyst particles may have a porous structure.

In one embodiment of the present disclosure, the catalyst particles may have a diameter of 0.1 nm to 500 μm, for example, 1 nm or more, or 10 nm or more, or 100 nm or more, or 1 μm or more, or 10 μm or more, or 400 μm or less, or 300 μm or less, or 200 μm or less, or 100 μm or less, or 50 μm or less. If the diameter of the catalyst particles is outside the above range, problems may arise in that the decomposition rate of recalcitrant/toxic organic substances is reduced and the decomposition performance is difficult to maintain.

In one embodiment of the present disclosure, the BET specific surface area of the catalyst may be 1 to 5,000 m²/g, for example, 1 m²/g or more, or 10 m²/g or more, or 100 m²/g or more, or 500 m²/g or more, or 1,000 m²/g or more, or 5,000 m²/g or less, or 2,500 m²/g or less, or 1,000 m²/g or less, or 500 m²/g or less. If the BET specific surface area of the catalyst particles is outside the above range, problems may arise in that at least one of ·OH productivity, NO₃·surface species productivity, H₂PO₄·/HPO₄·⁻/PO₄²·⁻ surface species productivity, SO₄·⁻ surface species productivity, aqueous NO₃·productivity or aqueous Cl·productivity is reduced or the decomposition rate of recalcitrant/toxic organic substances is reduced and the decomposition performance is difficult to maintain.

In one embodiment of the present disclosure, the pore volume of the catalyst may be 0.01 to 5 cm³/g, for example, 0.01 cm³/g or more, or 0.1 cm³/g or more, or 1 cm³/g or more, or 5 cm³/g or less, or 2.5 cm³/g or less, or 1 cm³/g or less. If the pore volume of the catalyst particles is outside the above range, problems may arise in that at least one of ·OH productivity, NO₃·surface species, H₂PO₄·/HPO₄·⁻/PO₄²·⁻ surface species productivity, SO₄·⁻ surface species productivity, aqueous NO₃·productivity or aqueous Cl·productivity is reduced or the decomposition rate of recalcitrant/toxic organic substances is reduced and the decomposition performance is difficult to maintain.

A second aspect of the present disclosure provides a method for producing a catalyst for an organic substance decomposition system, including a production step (S1) of producing catalyst particles including a non-reducible transition metal oxide.

Although detailed description of parts that overlap with those in the first aspect of the present disclosure has been omitted, the contents described for the first aspect of the present disclosure may be applied equally even if the description thereof is omitted in the second aspect.

Hereinafter, the method for producing a catalyst for an organic substance decomposition system according to the second aspect of the present disclosure will be described in detail.

In one embodiment of the present disclosure, the production method may further include a reduction step (S2) of reducing at least a portion of the surface of the catalyst particles by hydrogen treatment.

In one embodiment of the present disclosure, the hydrogen treatment may be performed using a reaction gas containing H₂.

In one embodiment of the present disclosure, the reduction step (S2) may be performed at 100° C. to 2,000° C. for 1 hour to 24 hours.

In one embodiment of the present disclosure, the production method may further include a functionalization step (S3) of attaching a functional group to at least a portion of the surface of the catalyst particles.

In one embodiment of the present disclosure, the functionalization step (S3) may be performed by nitrification, phosphorylation, or sulfation treatment.

In one embodiment of the present disclosure, the nitrification treatment may be performed using a reaction gas containing NO and O₂.

In one embodiment of the present disclosure, the phosphorylation treatment may be performed using a reaction solution containing a phosphorylation precursor.

In one embodiment of the present disclosure, the sulfation treatment may be performed using a reaction gas containing SO₂ and O₂.

The third aspect of the present disclosure provides an electrode for an organic substance decomposition system, including: a catalyst according to the present disclosure; a support on which the catalyst is supported; a substrate coated with the support; and a binder interposed between the support and the substrate.

Although detailed description of parts that overlap with those in the first and second aspects of the present disclosure has been omitted, the contents described for the first and second aspects of the present disclosure may be applied equally even if the description thereof is omitted in the third aspect.

Hereinafter, the electrode for an electrical or non-electrical organic substance decomposition system according to the third aspect of the present disclosure will be described in detail.

In one embodiment of the present disclosure, the catalyst may be in powder form.

In one embodiment of the present disclosure, the catalyst may be contained in an amount of 0.01 to 50 parts by weight based on 100 parts by weight of the support. If the content is out of the above range, problems may arise in that at least one of ·OH productivity, NO₃·surface species productivity, H₂PO₄·/HPO₄·⁻/PO₄²·⁻ surface species productivity, SO₄·⁻ surface species productivity, aqueous NO₃·productivity or aqueous Cl·productivity is reduced or the decomposition rate of recalcitrant/toxic organic substances is reduced and the decomposition performance is difficult to maintain.

In one embodiment of the present disclosure, the substrate may be made of any conductive material without limitation, and may include, for example, a conductive organic material (graphite, etc.), a conductive inorganic material (iridium dioxide (IrO₂), etc.), or the like.

In one embodiment of the present disclosure, the support may include at least one selected from the group consisting of carbon (C), Al₂O₃, MgO, ZrO₂, CeO₂, SiO₂, and combinations thereof.

In one embodiment of the present disclosure, the binder may be interposed between the support and the substrate to increase the adhesion therebetween.

In one embodiment of the present disclosure, the binder may be an insoluble polymer.

The fourth aspect of the present disclosure provides an organic substance decomposition system including: the electrode according to the present disclosure; and an aqueous electrolyte solution containing an acid.

Although detailed description of parts that overlap with those in the first to third aspects of the present disclosure has been omitted, the contents described for the first to third aspects of the present disclosure may be applied equally even if the description thereof is omitted in the fourth aspect.

Hereinafter, the organic substance decomposition system according to the fourth aspect of the present disclosure will be described in detail.

In one embodiment of the present disclosure, the acid may include at least one selected from the group consisting of nitric acid (HNO₃), phosphoric acid (H₃PO₄), sulfuric acid (H₂SO₄), hydrochloric acid (HCl), and combinations thereof.

In one embodiment of the present disclosure, the aqueous electrolyte solution may contain a supporting electrolyte, wherein the supporting electrolyte may preferably include at least one selected from the group consisting of sulfates (H₂SO₄, Li₂SO₄, Na₂SO₄, K₂SO₄, MgSO₄, etc.); nitrates (HNO₃, LiNO₃, NaNO₃, KNO₃, Mg(NO₃)₂, etc.); chlorides (HCl, LiCl, NaCl, KCl, MgCl₂, HClO₄, LiClO₄, NaClO₄, KClO₄, Mg(ClO₄)₂, etc.); phosphates (H₃PO₄, Li₃PO₄, Na₃PO₄, K₃PO₄, Mg₃(PO₄)₂, etc.); hydroxides (LiOH, NaOH, KOH, Mg(OH)₂, etc.); and combinations thereof, and the concentration of the supporting electrolyte may be 10⁻⁵ mol L⁻¹ to 10⁵ mol L⁻¹. If the concentration is out of the above range, problems may arise in that at least one of ·OH productivity, NO₃·surface species productivity, H₂PO₄·/HPO₄·⁻/PO₄²·⁻ surface species productivity, SO₄·⁻ surface species productivity, aqueous NO₃·productivity or aqueous Cl·productivity is reduced or the decomposition rate of recalcitrant/toxic organic substances is reduced and the decomposition performance is difficult to maintain.

In one embodiment of the present disclosure, the pH of the aqueous electrolyte solution may be less than 2. If the pH of the aqueous electrolyte solution is 2 or more, problems may arise in that at least one of ·OH productivity, NO₃·surface species productivity, H₂PO₄·/HPO₄·⁻/PO₄²·⁻ surface species productivity, SO₄·⁻ surface species productivity, aqueous NO₃·productivity or aqueous Cl·productivity is reduced or the decomposition rate of recalcitrant/toxic organic substances is reduced and the decomposition performance is difficult to maintain.

In one embodiment of the present disclosure, the system may be used in a method in which H₂O₂ or O₃ is converted into ·OH radicals by homolysis and the converted radicals decompose organic substances.

In one embodiment of the present disclosure, the system may be used in a process of decomposing organic substances under electrical or non-electrical conditions.

In one embodiment of the present disclosure, the electrical process may be a process in which the catalyst is immersed in the aqueous electrolyte solution in a state in which the support is coated with the catalyst (with increased adhesion by the binder), so that H₂O₂, a precursor of ·OH radicals, is produced in the aqueous electrolyte solution, or the aqueous electrolyte solution may contain O₃.

In one embodiment of the present disclosure, the non-electrical process may be a process which includes H₂O₂ or O₃, a precursor of ·OH radicals, and in which the catalyst is dispersed in powder form in the aqueous solution, or the catalyst is supported on the support and the support is immersed in the aqueous solution in a state in which the support is coated with the support (with increased adhesion by the binder).

In one embodiment of the present disclosure, the system may be configured to cause an organic substance decomposition reaction at a power input of 10 W or less.

A fifth aspect of the present disclosure provides a decomposition method using the organic substance decomposition system according to the present disclosure.

Although detailed description of parts that overlap with those in the first to fourth aspects of the present disclosure has been omitted, the contents described for the first to fourth aspects of the present disclosure may be applied equally even if the description thereof is omitted in the fifth aspect.

Hereinafter, the decomposition method according to the fifth aspect of the present disclosure will be described in detail.

In one embodiment of the present disclosure, the method for decomposing organic substances may include: a step in which aqueous ·OH species is formed by homolysis of H₂O₂; a step in which functionalized NO₃⁻ surface species, H₂PO₄⁻/HPO₄²⁻/PO₄³⁻ surface species or SO₄²⁻ surface species is converted into NO₃·surface species, H₂PO₄·/HPO₄·⁻/PO₄²·⁻ surface species or SO₄·⁻ surface species by the aqueous ·OH species; a step in which aqueous NO₃⁻, aqueous PO₄³⁻, aqueous SO₄²⁻ or aqueous Cl⁻ is converted into aqueous NO₃·, aqueous H₂PO₄·/HPO₄·⁻/PO₄²·⁻, aqueous SO₄·⁻ or aqueous Cl·by the aqueous ·OH species; and a step in which recalcitrant/toxic organic substances are decomposed by at least one radical species among the aqueous ·OH, the NO₃·surface species, the H₂PO₄·/HPO₄·⁻/PO₄²·⁻ surface species, the SO₄·⁻ surface species, the aqueous NO₃·, the aqueous H₂PO₄·/HPO₄·⁻/PO₄²·⁻, the aqueous SO₄·⁻ and the aqueous Cl·.

Through this decomposition method, it is possible to almost completely avoid leaching of catalyst particles that occurs during decomposition of recalcitrant/toxic organic substances, and thus the organic substance decomposition performance may be maintained during multiple system operations, and it is possible to improve the catalyst life.

Hereinafter, examples of the present disclosure will be described in detail so that those skilled in the art can easily carry out the present disclosure. However, the present disclosure may be embodied in various different forms and is not limited to the examples described herein.

### PRODUCTION EXAMPLES

Components and conditions of the electrical or non-electrical organic substance decomposition systems of the present disclosure proposed for decomposing 0.1 mmol of acetaminophen (except Example 17) or nitrobenzene (Example 17) dissolved in 100 mL of distilled water were divided into 20 examples and shown in Table 2, and the improved acetaminophen decomposition efficiency of the proposed organic substance decomposition systems was compared with that of 9 comparative examples.

TABLE 2

| Example/ | | | | | | | |
|---|---|---|---|---|---|---|---|
| Comparative | | | | Supporting | | | Hydrogen |
| Example | Catalyst | Acid | pH | electrolyte | Voltage | Scavenger | peroxide |
| Example 1 | ZrO₂ | Nitric acid | 1 | — | 3 V | — | — |
| | (0.2 g) | (14.0 mmol) | | | | | |
| Example 2 | ZrO₂ | Nitric acid | 1 | Na₂SO₄ | 3 V | — | — |
| | (0.2 g) | (29.2 mmol) | | (0.14 mmol) | | | |
| Example 3 | ZrO₂ | Nitric acid | 1 | — | 3 V | — | — |
| | (0.2 g) | (14.0 mmol) | | | | | |
| Example 4 | ZrO₂ | Nitric acid | 1 | — | 3 V | Hydroquinone | — |
| | (0.2 g) | (14.0 mmol) | | | | (14.0 mmol) | |
| Example 5 | ZrO₂ | Nitric acid | 1 | — | 3 V | Tert-butanol | |
| | (0.2 g) | (14.0 mmol) | | | | (14.0 mmol) | |
| Example 9 | O300 | Nitric acid | 1 | — | 3 V | — | — |
| | (0.2 g) | (14.0 mmol) | | | | | |
| Example 10 | R600 | Nitric acid | 1 | — | 3 V | — | — |
| | (0.2 g) | (14.0 mmol) | | | | | |
| Example 11 | R600-N | Nitric acid | 1 | — | 3 V | — | — |
| | (0.2 g) | (14.0 mmol) | | | | | |
| Example 12 | R600-P | Nitric acid | 1 | — | 3 V | — | — |
| | (0.2 g) | (14.0 mmol) | | | | | |
| Example 13 | R600-S | Nitric acid | 1 | — | 3 V | — | — |
| | (0.2 g) | (14.0 mmol) | | | | | |
| Example 14 | ZrO₂ | Nitric acid | 1 | Na₂SO₄ | — | — | 30 mmol |
| | (0.2 g) | (29.2 mmol) | | (0.14 mmol) | | | |
| Example 15 | ZrO₂ | Hydrochloric | 1 | — | 3 V | — | — |
| | (0.2 g) | acid | | | | | |
| | | (26.6 mmol) | | | | | |
| Example 16 | ZrO₂ | Hydrochloric | 1 | Na₂SO₄ | 3 V | — | — |
| | (0.2 g) | acid | | (0.14 mmol) | | | |
| | | (23.4 mmol) | | | | | |
| Example 17 | ZrO₂ | Hydrochloric | 1 | — | 3 V | — | — |
| | (0.2 g) | acid | | | | | |
| | | (26.6 mmol) | | | | | |
| Example 21 | O300 | Hydrochloric | 1 | — | 3 V | — | — |
| | (0.2 g) | acid | | | | | |
| | | (26.6 mmol) | | | | | |
| Example 22 | R600 | Hydrochloric | 1 | — | 3 V | — | — |
| | (0.2 g) | acid | | | | | |
| | | (26.6 mmol) | | | | | |
| Example 23 | R600-N | Hydrochloric | 1 | — | 3 V | — | — |
| | (0.2 g) | acid | | | | | |
| | | (26.6 mmol) | | | | | |
| Example 24 | R600-P | Hydrochloric | 1 | — | 3 V | — | — |
| | (0.2 g) | acid | | | | | |
| | | (26.6 mmol) | | | | | |
| Example 25 | R600-S | Hydrochloric | 1 | — | 3 V | — | — |
| | (0.2 g) | acid | | | | | |
| | | (26.6 mmol) | | | | | |
| Example 26 | ZrO₂ | Hydrochloric | 1 | Na₂SO₄ | — | — | 30 mmol |
| | (0.2 g) | acid | | (0.14 mmol) | | | |
| | | (23.4 mmol) | | | | | |
| Comparative | ZrO₂ | Nitric acid | 1 | — | — | — | — |
| Example 1 | (0.2 g) | (14.0 mmol) | | | | | |
| Comparative | — | Nitric acid | 1 | — | 3 V | — | — |
| Example 2 | | (14.0 mmol) | | | | | |
| Comparative | ZrO₂ | — | 4.9 | Na₂SO₄ | 3 V | — | — |
| Example 3 | (0.2 g) | | | (0.14 mmol) | | | |
| Comparative | ZrO₂ | — | 4.8 | Na₂SO₄ | 3 V | — | — |
| Example 4 | (0.2 g) | | | (29.2 mmol) | | | |
| Comparative | — | Nitric acid | 1 | Na₂SO₄ | — | — | 30 mmol |
| Example 5 | | (29.2 mmol) | | (0.14 mmol) | | | |
| Comparative | ZrO₂ | Hydrochloric | 1 | — | — | — | — |
| Example 6 | (0.2 g) | acid | | | | | |
| | | (26.6 mmol) | | | | | |
| Comparative | — | Hydrochloric | 1 | — | 3 V | — | — |
| Example 7 | | acid | | | | | |
| | | (26.6 mmol) | | | | | |
| Comparative | ZrO₂ | — | 4.8 | Na₂SO₄ | 3 V | — | — |
| Example 8 | (0.2 g) | | | (23.4 mmol) | | | |
| Comparative | — | Hydrochloric | 1 | Na₂SO₄ | — | — | 30 mmol |
| Example 9 | | acid | | (0.14 mmol) | | | |
| | | (23.4 mmol) | | | | | |

The methods for producing catalysts constituting the electrical or non-electrical organic substance decomposition systems of the present disclosure are described below.

### Production of ZrO₂ Catalyst

6.4 g of ZrOCl₂·8H₂O and 5.0 g of C₂H₂O₄·2H₂O were dissolved in 100 mL of distilled water at 50° C. and stirred at 50° C. for 30 minutes, and the precipitate was collected. The obtained precipitate was dried at 70° C. for 18 hours and then calcined at 400° C. for 2 hours, thereby synthesizing ZrO₂.

### Production of O300 Catalyst

6.9 g of H₂SO₄ and 11.25 g of TiOSO₄ were dissolved in 37.5 mL of distilled water, stirred at 50° C. for 3 hours, mixed with 75 g of urea dissolved in 500 mL of distilled water, and stirred under reflux at 110° C. for 18 hours. The intermediate product was cooled to 25° C., filtered, rinsed with 2 L of distilled water, and then dried at room temperature for 3 hours to obtain TiO(OH)₂ which was then calcined at 300° C. for 3 hours, thereby synthesizing O300.

### Production of R600 Catalyst

TiO(OH)₂ was reduced with 10 vol % H₂/He at 600° C. for 3 hours, thereby synthesizing R600.

### Production of R600-N, R600-P and R600-S Catalysts

The R600 catalyst was placed in a reactor, and nitrogen monoxide (NO) and oxygen (O₂) diluted with N₂ were simultaneously introduced into the reactor at a flow rate of 500 mL min⁻¹. The mixture was exposed at 100° C. under normal pressure for 2 hours, and then cooled to room temperature under a N₂ atmosphere. The content of nitrogen monoxide in the exposure step was 5,000 ppm and the content of oxygen was 3 vol %. An R600-N catalyst functionalized with NO₃⁻ was produced under the above-described conditions.

In addition, 2 g of the R600 catalyst was added to a 200 mL aqueous solution containing 4 mmol of ammonium hydrogen phosphate ((NH₄)₂HPO₄), stirred at 25° C. for 24 hours, dried, and then calcined at 250° C. for 3 hours. An R600-P catalyst functionalized with H₂PO₄⁻/HPO₄²⁻/PO₄³⁻ was produced under the above conditions.

In addition, the R600 catalyst was placed in a reactor, and sulfur dioxide (SO₂) and oxygen (O₂) diluted with N₂ were simultaneously into the reactor introduced at a flow rate of 500 mL min₋₁. The mixture was exposed at 300° C. under normal pressure for 1 hour, and then cooled to room temperature under a N₂ atmosphere. The content of sulfur dioxide in the exposure step was 500 ppm, and the content of oxygen was 3 vol %. Under the above conditions, an R600-S catalyst functionalized with SO₄²⁻ was produced.

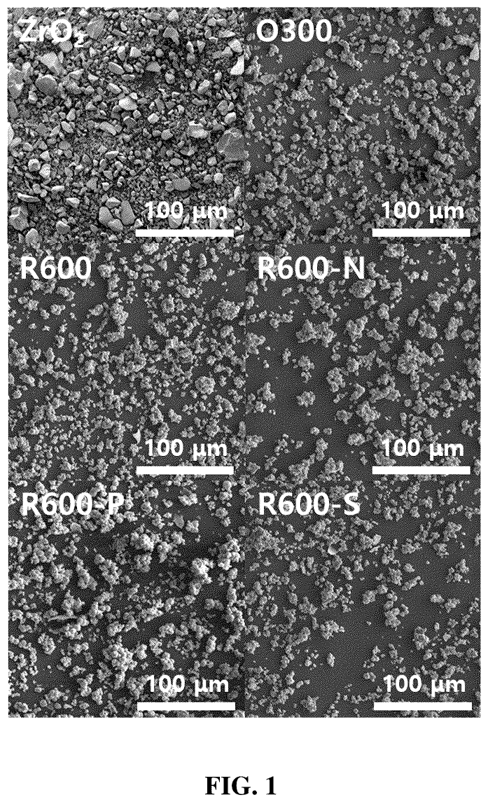

FIG. 1 shows the morphologies of TiO₂ catalyst particles (O300), surface-reduced TiO₂ catalyst particles (R600), surface-reduced TiO₂ catalyst particles functionalized with NO₃⁻ (R600-N), surface-reduced TiO₂ catalyst particles functionalized with H₂PO₄⁻/HPO₄²⁻/PO₄³⁻ (R600-P), and surface-reduced TiO₂ catalyst particles functionalized with SO₄²⁻ (R600-S). As shown in FIG. 1, it can be seen that, when the catalyst particles are small in size (100 μm or less) or have a rough surface including protrusions, the surface area increases and the hydrogen peroxide homolysis (H₂O₂→2·OH) becomes faster, and thus 1) the formation rate of aqueous ·OH may become faster, 2) the rate of conversion of catalyst surface NO₃/H₂PO₄⁻/HPO₄²⁻/PO₄³⁻/SO₄²⁻ functional groups into NO₃·/H₂PO₄·/HPO₄·⁻/PO₄²·⁻/SO₄·⁻ surface species by aqueous ·OH (·OH+NO₃⁻ (catalyst surface)→OH⁻+NO₃·(catalyst surface); ·OH+H₂PO₄⁻ (catalyst surface)→OH⁻+H₂PO₄·(catalyst surface); ·OH+HPO₄²⁻ (catalyst surface)→OH⁻+HPO₄·⁻ (catalyst surface); ·OH+PO₄³⁻ (catalyst surface)→OH⁻+PO₄²·— (catalyst surface); ·OH+SO₄²⁻ (catalyst surface)→OH⁻+SO₄·⁻ (catalyst surface)) may become faster, and the rate of conversion of aqueous NO₃⁻/Cl⁻ into aqueous NO₃·/Cl·by aqueous ·OH species (·OH+NO₃⁻ (aq)→OH⁻+NO₃·(aq); ·OH+HNO₃ (aq)→H₂O+NO₃·(aq); ·OH+Cl⁻ (aq)→OH⁻+Cl·(aq); ·OH+HCl (aq)→H₂O+Cl·(aq)) may become faster.

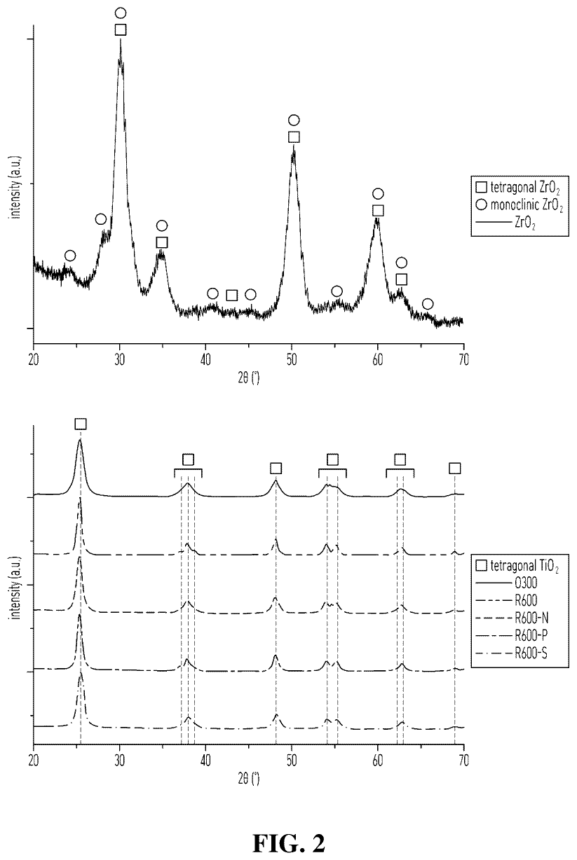

The catalysts produced according to the above-described methods were analyzed using an X-ray diffractometer (XRD), and the resulting X-ray diffraction (XRD) patterns are shown in FIG. 2. Referring to FIG. 2, it can be seen that ZrO₂ has crystal phases of monoclinic and tetragonal ZrO₂. In addition, it can be seen that O300, R600, R600-N, R600-P, and R600-S have a crystal phase of tetragonal TiO₂, which means that reduction with hydrogen at 600° C. or functionalization with NO₃⁻/H₂PO₄⁻/HPO₄²⁻/PO₄³⁻/SO₄²⁻ did not affect the bulk phase of TiO₂, but could affect the properties of the Brønsted acid active species (—OH) and Lewis acid active species (Ti⁴⁺) existing on the TiO² surface, and only the TiO₂ surface was modified by the NO₃⁻/H₂PO₄⁻/HPO₄²⁻/PO₄³⁻/SO₄²⁻ functional groups.

TABLE 3

| Catalyst | ZrO₂ | O300 | R600 | R600-N | R600-P | R600-S |
|---|---|---|---|---|---|---|
| S_{BET} ^{a} (m² g_{CAT}⁻¹) | 110.5 | 245.6 | 79.1 | 70.2 | 35.4 | 36.5 |
| V_{BJH} ^{b} (cm³ g_{CAT}⁻¹) | 0.3 | 0.3 | 0.3 | 0.2 | 0.1 | 0.1 |
| N/Ti (bulk) ^{c, d} | — | — | — | 0.01 | — | — |
| N/Ti (surface) ^{e} | — | — | — | 0.11 | — | — |
| P/Ti (bulk) ^{c} | — | — | — | — | 0.14 | — |
| P/Ti (surface) ^{e} | — | — | — | — | 0.31 | — |
| S/Ti (bulk) ^{c} | — | — | — | — | — | 0.15 |
| S/Ti (surface) ^{e} | — | — | — | — | — | 0.33 |
| band gap ^{f} (eV) | — | 3.3 | 3.1 | 3.1 | 3.1 | 3.1 |

^{a} via BET.
^{b} via BJH.
^{c} via ICP.
^{d} via EA.
^{e} via XPS.
^{f} via Tauc plot.

The produced catalysts exhibit porous morphology, which is evidenced by the BET surface area (S_{BET}) and BJH pore volume (V_{BJH}) values of the catalysts. In addition, the catalysts of R600-N, R600-P and R600-S contain N, P and S in the bulk and on the surface (N/Ti, P/Ti and S/Ti molar ratios) as determined by quantitative analyses using ICP/EA and XPS, which means that the R600 surface was functionalized with NO₃⁻/H₂PO₄⁻/HPO₄²⁻/PO₄³⁻/SO₄²⁻.

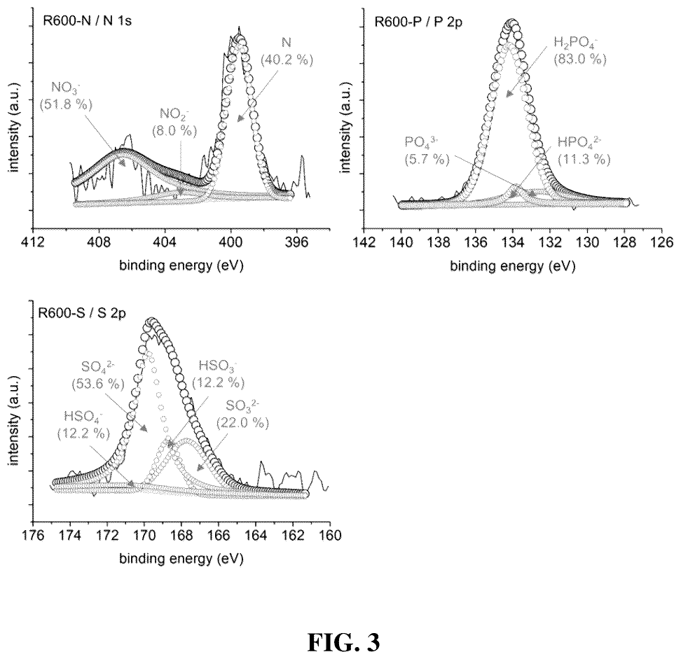

FIG. 3 depicts graphs showing the results of XPS of the R600-N, R600-P, and R600-S catalysts functionalized with NO₃⁻/H₂PO₄⁻/HPO₄²⁻/PO₄³⁻/SO₄²⁻ (for R600-N, N 1s; for R600-P, P 2p; for R600-S, S 2p). As evidenced by the XPS results, it can be seen that R600-N, R600-P, and R600-S contain NO₃⁻/H₂PO₄⁻/HPO₄²⁻/PO₄³⁻/SO₄²⁻ functional groups on their surfaces. Specifically, this means that, since the R600-N, R600-P and R600-S catalysts contain N/P/S in the bulk and on the surface (Table 2) and contain NO₃⁻/H₂PO₄⁻/HPO₄²⁻/PO₄³⁻/SO₄²⁻ functional groups on the surface, they can generate NO₃·surface species, H₂PO₄·/HPO₄·⁻/PO₄²·⁻ surface species and SO₄·⁻ surface species on the basis of radical transfer reactions (NO₃⁻ (catalyst surface)+·OH→NO₃·(catalyst surface)+OH⁻, H₂PO₄⁻ (catalyst surface)+·OH→H₂PO₄·(catalyst surface)+OH⁻; HPO₄²⁻ (catalyst surface)+·OH→HPO₄·⁻ (catalyst surface)+OH⁻; PO₄³⁻ (catalyst surface)+·OH→PO₄²·⁻ (catalyst surface)+OH⁻ and SO₄²⁻ (catalyst surface)+·OH→SO₄·⁻ (catalyst surface)+OH⁻).

The band gaps of the O300, R600, R600-N, R600-P, and R600-S catalysts were quantified using Tauc plots, and the results are shown in Table 3 above. As a result, the band gaps of the O300, R600, R600-N, R600-P, and R600-S catalysts were observed to be 3.1 to 3.3 eV, which means that the O300, R600, R600-N, R600-P, and R600-S catalysts cannot activate the reactions that produce radicals by the semiconducting mechanism or heterojunction mechanism under visible light as described above.

All of the above-described analytical results imply that the ZrO₂, O300, R600, R600-N, R600-P, and R600-S catalysts can activate the homolysis of hydrogen peroxide using the Brønsted acid active species and Lewis acid active species existing on the surface to produce aqueous ·OH, and that the R600-N, R600-P, and R600-S catalysts can produce NO₃·surface species, H₂PO₄·/HPO₄·⁻/PO₄²·⁻ surface species and SO₄·⁻ surface species based on the radical transfer mechanism.

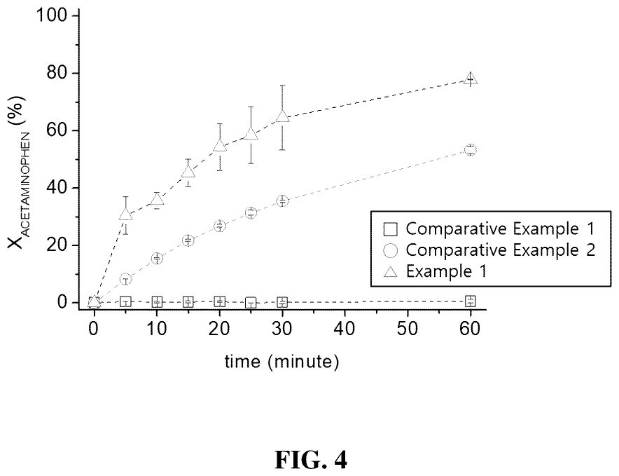

Hereinafter, the acetaminophen or nitrobenzene decomposition performance of an electrical or non-electrical organic substance decomposition system using the ZrO₂, O300, R600, R600-N, R600-P or R600-S under the conditions detailed in Table 2 will be described with reference to FIGS. 4 to 15.

### Experimental Example 1: Acetaminophen Decomposition System I Under Electrical Conditions

For the decomposition of 0.1 mmol of acetaminophen in 100 mL of an acidic aqueous solution containing 14.0 mmol of nitric acid, 0.2 g of ZrO₂ was used as a catalyst, a graphite electrode was used as an electrode, polyvinylidene fluoride (PVDF) was used as a binder for coating the electrode with the catalyst. Under these conditions, the reaction for acetaminophen decomposition was performed for 60 minutes at a voltage of 3 V, a power input of 2 W, 25° C. and pH 1, and this was named Example 1. In addition, acetaminophen adsorption was performed for 60 minutes under the same conditions as in Example 1 in the absence of the voltage of 3 V and the power of 2 W, and this is named Comparative Example 1. In addition, acetaminophen decomposition was performed for 60 minutes under the same conditions as in Example 1 in the absence of 0.2 g of ZrO₂, and this was named Comparative Example 2. The results (conversion of acetaminophen (X_{ACETAMINOPHEN}) versus time) of Example 1 and Comparative Examples 1 and 2 are shown in FIG. 4. In the case of Comparative Example 1, the conversion of acetaminophen is 0%, which means that the amount of acetaminophen adsorbed on the ZrO₂ catalyst surface is negligibly small. In the case of Comparative Example 2, the conversion of acetaminophen is attributable to oxidation occurring at the anode (anodic oxidation). On the other hand, in the case of Example 1, the conversion of acetaminophen (X_{ACETAMINOPHEN}) can be attributed to the following four factors: 1) oxidation occurring at the anode (anodic oxidation); 2) homolysis of H₂O₂ (production of aqueous ·OH) by the Brønsted acid active species (—OH) and Lewis acid active species (Zr⁴⁺) leached from the ZrO₂ catalyst surface; 3) homolysis of H₂O₂ (production of aqueous ·OH) by the Brønsted acid active species (—OH) and Lewis acid active species (Zr⁴⁺) existing on the ZrO₂ catalyst surface; and 4) conversion of aqueous ·OH to aqueous NO₃·(·OH+NO₃⁻ (aq)→OH⁻+NO₃·(aq) or ·OH+HNO₃ (aq)→H₂O+NO₃·(aq)) based on the radical transfer mechanism. Importantly, the amount of Zr leached into the aqueous solution in Example 1 was measured to be 10⁻³ mol %, which means that the decomposition of acetaminophen by 2) above was negligible. Also importantly, the acetaminophen conversion values of Example 1 are about 25 to 30% higher than the acetaminophen conversion values of Comparative Example 2, which means that anodic oxidation, aqueous ·OH, and aqueous NO₃·contribute comprehensively to the decomposition of acetaminophen in Example 1, and demonstrates the superiority of the organic substance decomposition system under electrical conditions proposed in the present disclosure.

### Experimental Example 2: Acetaminophen Decomposition System II Under Electrical Conditions

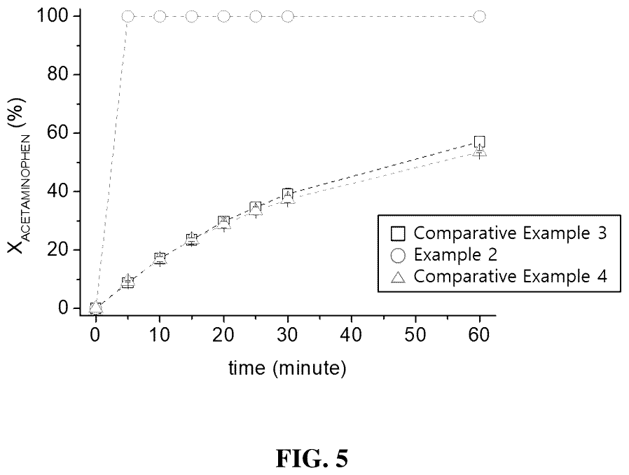

For the decomposition of 0.1 mmol of acetaminophen in 100 mL of an acidic aqueous solution containing 29.2 mmol of nitric acid and 0.14 mmol of Na₂SO₄ (supporting electrolyte), 0.2 g of ZrO₂ was used as a catalyst, a graphite electrode was used as an electrode, polyvinylidene fluoride (PVDF) was used as a binder for coating the electrode with the catalyst. Under these conditions, the reaction for acetaminophen decomposition was performed for 60 minutes at a voltage of 3 V, a power input of 2 W, 25° C. and pH 1, and this was named Example 2. In addition, the reaction for acetaminophen decomposition was performed for 60 minutes (pH 4.9) under the same conditions as in Example 2 in the absence of 29.2 mmol of nitric acid, and this was named Comparative Example 3. In addition, the reaction for acetaminophen decomposition was performed for 60 minutes (pH 4.8) under the same conditions as in Example 2 in the absence of 29.2 mmol of nitric acid and the presence of 29.2 mmol of Na₂SO₄, and this was named Comparative Example 4. The results (conversion of acetaminophen (X_{ACETAMINOPHEN}) versus time) of Example 2 and Comparative Examples 3 to 4 are shown in FIG. 5. Importantly, the amount of Zr leached into the aqueous solution in Example 2 and Comparative Examples 3 to 4 was measured to be 10⁻³ mol %, which means that the decomposition of acetaminophen by aqueous ·OH formed as a result of the homolysis of H₂O₂ by the Brønsted acid active species (—OH) and Lewis acid active species (Zr₄₊) leached from the ZrO₂ catalyst surface is negligible. In the case of Comparative Examples 3 and 4, the conversion values of acetaminophen were similar regardless of the change in the amount (0.14 mmol or 29.2 mmol) of Na₂SO₄ (supporting electrolyte), which means that the improvement in acetaminophen decomposition efficiency by the supporting electrolyte was negligibly small. Also importantly, the conversion values of acetaminophen in Comparative Examples 3 and 4 are attributable to oxidation occurring at the anode (anodic oxidation) and the homolysis of H₂O₂ (production of aqueous ·OH) by the Brønsted acid active species (—OH) and Lewis acid active species (Zr⁴⁺) existing on the ZrO₂ catalyst surface. In contrast, the conversion values of acetaminophen in Example 2 are attributable to 1) oxidation occurring at the anode (anodic oxidation), 2) the homolysis of H₂O₂ (production of aqueous ·OH) by the Brønsted acid active species (—OH) and Lewis acid active species (Zr⁴⁺) existing on the ZrO₂ catalyst surface, and 3) the conversion of aqueous ·OH to aqueous NO₃·(·OH+NO₃⁻ (aq)→OH⁻+NO₃·(aq) or ·OH+HNO₃ (aq)→H₂O+NO₃·(aq)) based on the radical transfer mechanism. The conversion values of acetaminophen in Example 2 were 100% after 5 minutes, which means that the aqueous NO₃·in 3) above significantly enhances the acetaminophen decomposition efficiency, and demonstrates the superiority of the organic substance decomposition system under electrical conditions proposed in the present disclosure. In addition, the conversion values of acetaminophen in Example 2 are significantly greater than those of acetaminophen in Example 1, which means that the use of an appropriate concentration of the supporting electrolyte is significantly desirable for improving the aqueous NO₃·productivity and the efficiency of decomposition of acetaminophen.

### Experimental Example 3: Acetaminophen Decomposition System III Under Electrical Conditions

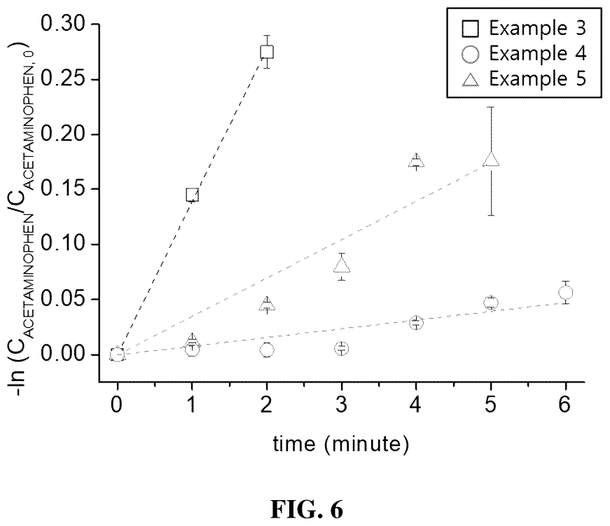

For the decomposition of 0.1 mmol of acetaminophen in 100 mL of an acidic aqueous solution containing 14.0 mmol of nitric acid, 0.2 g of ZrO₂ was used as a catalyst, a graphite electrode was used as an electrode, and polyvinylidene fluoride (PVDF) was used as a binder for coating the electrolyte with the catalyst. Under these conditions, the reaction for acetaminophen decomposition was performed for 60 minutes at a voltage of 3 V, a power input of 2 W, 25° C. and pH 1, and this was named Example 3. In addition, the reaction for acetaminophen decomposition was performed for 60 minutes under the same conditions as in Example 3 in the presence of 14.0 mmol of hydroquinone, and this was named Example 4. In addition, the reaction for acetaminophen decomposition was performed for 60 minutes under the same conditions as in Example 3 in the presence of 14.0 mmol of tert-butanol, and this was named Example 5. The conversion values of acetaminophen obtained in the above experiments were corrected using those of anodic oxidation, and the rate constant (k_{APP}, min⁻¹) of the reaction for decomposing acetaminophen was determined using the slope of the pseudo-1^{st}-order kinetic fitting graph (−ln (C_{ACETAMINOPHEN}/C_{ACETAMINOPHEN, 0}) versus time) of FIG. 6 obtained using the conversion values of acetaminophen obtained after correction. The k_{APP} values of Examples 3 to 5 are attributable to the homolysis of H₂O₂ (production of aqueous ·OH) by the Brønsted acid active species (—OH) and Lewis acid active species (Zr4+) existing on the ZrO₂ catalyst surface, and the conversion of aqueous ·OH into aqueous NO³·(·OH+NO₃⁻ (aq)→OH⁻+NO₃·(aq) or ·OH+HNO₃ (aq)→H₂O+NO₃·(aq)) based on the radical transfer mechanism. Hydroquinone and tert-butanol added in Examples 4 and 5 function as scavengers, and the ability of the scavenger to quench a specific radical (ZZZ) is proportional to the secondary deradicalization rate constant (k_{ZZZ}; L mol⁻¹ sec⁻¹) of the scavenger. As shown in FIG. 6, the magnitude of the k_{APP} values shows a tendency of Example 3 (absence of scavenger; 140×10⁻³ min⁻¹)>Example 5 (presence of tert-butanol; 8×10⁻³ min⁻¹)>Example 4 (presence of hydroquinone; 8×10⁻³ min⁻¹). On the other hand, the k·_{OH} values of tert-butanol and hydroquinone (tert-butanol (5.7×10⁸ L mol⁻¹ sec⁻¹); hydroquinone (5.2×10⁹ L mol⁻¹ sec⁻¹)) are similar, which means that the major radical that decomposes acetaminophen is not the aqueous ·OH. On the other hand, the k_{NO3}·values of tert-butanol and hydroquinone are tert-butanol (5.7×10⁴ L mol⁻¹ sec⁻¹)<hydroquinone (8.8×10⁸ L mol⁻¹ sec⁻¹), which means that the major radical that decomposes acetaminophen is aqueous NO3·, and the activation of ·OH+NO₃⁻ (aq)→OH⁻+NO₃·(aq) or ·OH+HNO₃ (aq)→H₂O+NO₃·(aq) can be significantly promoted below pH 2, which is consistent with the result of Experimental Example 2 indicating that aqueous NO³·significantly promotes the efficiency of decomposition of acetaminophen.

### Experimental Example 4: Electron Paramagnetic Resonance Spectroscopy Analysis

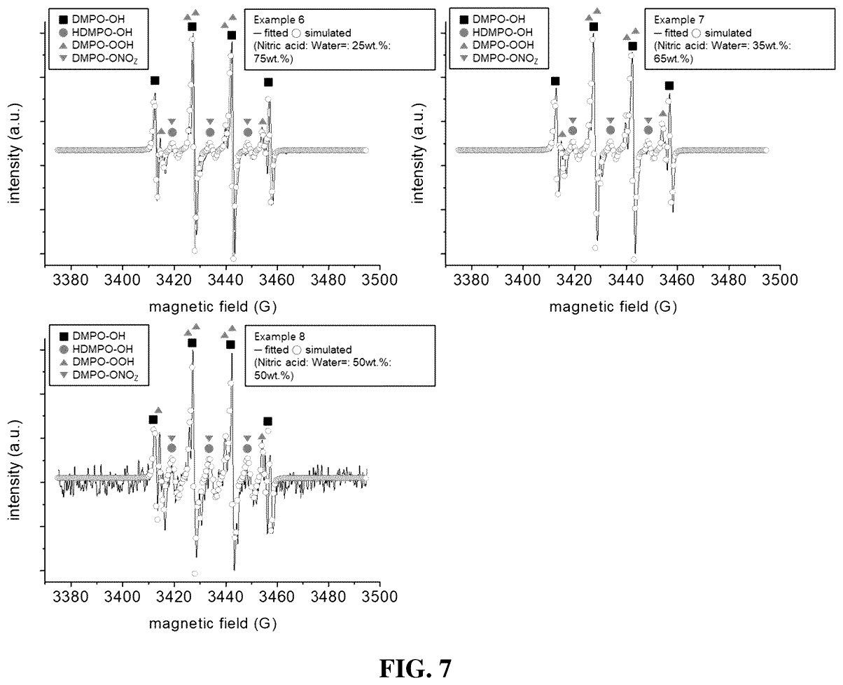

To investigate the radical productivity of the ZrO₂ catalyst dispersed in nitric acid solution in the presence of hydrogen peroxide, such as aqueous ·OH/·OOH/O₂·⁻ productivity and aqueous NO₃·productivity, 0.1 g of ZrO₂ and 0.08 g of 5,5-dimethyl-1-pyrroline N-oxide (DMPO), a spin-trapping agent for radicals, were added to 0.14 mL of distilled water and stirred for 3 minutes. The reaction solution was then collected using a filter, and liquid electron paramagnetic resonance (EPR) spectroscopy analysis was performed at room temperature. Here, the concentration of nitric acid added to the distilled water was adjusted to 25 wt % (Example 6), 35 wt % (Example 7), and 50 wt % (Example 8), and the pH of the aqueous solution was less than 2. Hydrogen peroxide reacts with the Brønsted acid active species and Lewis acid active species of the ZrO₂ catalyst to produce aqueous ·OH/·OOH/O₂·⁻, and the produced radicals are trapped by DMPO to form DMPO-OH (·OH; black squares) and DMPO-OOH (·OOH/O₂·⁻; green triangles) products. In addition, DMPO-OH is oxidized to form HDMPO, and aqueous ·OH is additionally trapped by some of the HDMPO to form an HDMPO-OH (red circle) product, or aqueous NO₃·is additionally trapped by some of the HDMPO to form an HDMPO-ONO₂ (blue inverted triangle) product. Since the above-described DMPO-based products contain radicals, they may be monitored in the form of signals during EPR spectroscopy analysis and used to analyze the concentration of radicals present in the reaction solution. As shown in FIG. 7 and Table 4 below, as the concentration of HNO3 increases from 25 wt %→35 wt %→50 wt %, the concentration of DMPO-OH decreases (69.8%→46.5%) and the concentration of HDMPO-ONO2 increases (5.7%→23.3%). This is because as the concentration of nitric acid in the reaction solution increases, the equilibrium of ·OH+NO₃⁻ (aq)↔OH⁻+NO₃·(aq) or ·OH+HNO₃ (aq)↔H₂O+NO₃·(aq) shifts to the right, thus increasing the concentration of aqueous NO³·. Importantly, this means that as the pH of the organic substance decomposition system proposed in the present disclosure decreases, the concentration of the aqueous NO³·, which is mainly used for the decomposition of recalcitrant/toxic organic substances, may increase.

TABLE 4

| | Concentration (%) | | | |
|---|---|---|---|---|
| | | | | HDMPO- |
| | DMPO-OH | HDMPO-OH | DMPO-OOH | ONO₂ |
| 25 wt % HNO₃ | 69.8 | 1.2 | 23.3 | 5.7 |
| 35 wt % HNO₃ | 61.7 | 1.2 | 30.9 | 6.2 |
| 50 wt % HNO₃ | 46.5 | 1.1 | 29.1 | 23.3 |

### Experimental Example 5: Acetaminophen Decomposition System IV Under Electrical Conditions

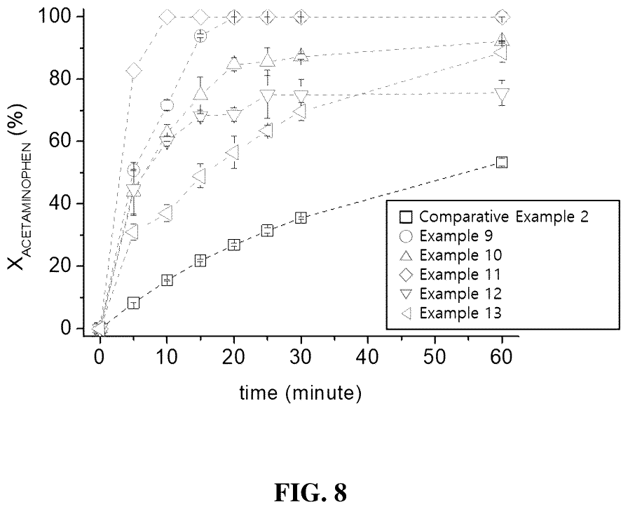

For the decomposition of 0.1 mmol of acetaminophen in 100 mL of an acidic aqueous solution containing 14.0 mmol of nitric acid, 0.2 g of O300 was used as a catalyst in Example 9, 0.2 g of R600 was used as a catalyst in Example 10, 0.2 g of R600-N was used as a catalyst in Example 11, 0.2 g of R600-P was used as a catalyst in Example 12, 0.2 g of R600-S was used as a catalyst in Example 13, a graphite electrode was used as an electrode, and polyvinylidene fluoride (PVDF) was used as a binder for coating the electrode with the catalyst. The reaction in each Example was performed for 60 minutes at a voltage of 3 V, a power input of 2 W, 25° C. and pH 1, and these are named Examples 9 to 13. In addition, acetaminophen decomposition was performed for 60 minutes under the same conditions as in Examples 9 to 13 in the absence of 0.2 g of the catalyst, and this was named Comparative Example 2. The results (conversion of acetaminophen (X_{ACETAMINOPHEN}) versus time) of Examples 9 to 13 and Comparative Example 2 are shown in FIG. 8. The amount of Ti leached into the aqueous solution of Examples 9 to 13 was measured to be 10⁻³ mol %, which means that the decomposition of acetaminophen by aqueous ·OH produced as a result of the H₂O₂ homolysis by the Brønsted acid active species (—OH) and Lewis acid active species (Ti⁴⁺) leached from the O300, R600, R600-N, R600-P or R600-S catalyst surface is negligible. In the case of Comparative Example 2, the conversion of acetaminophen is attributed to oxidation occurring at the anode (anodic oxidation). On the other hand, in the case of Examples 9 to 13, the conversion of acetaminophen (X_{ACETAMINOPHEN}) can be attributed to the following four factors: 1) oxidation occurring at the anode (anodic oxidation); 2) the homolysis of H₂O₂ (production of aqueous ·OH) by the Brønsted acid active species (—OH) and Lewis acid active species (Ti⁴⁺) existing on the surface of the O300, R600, R600-N, R600-P or R600-S catalyst; 3) in the case of R600-N, the conversion of aqueous ·OH into NO₃·surface species (NO₃⁻ (catalyst surface)+·OH→NO₃·(catalyst)+OH⁻) based on the radical transfer mechanism, or in the case of R600-P, the conversion of aqueous ·OH into H₂PO₄·/HPO₄·⁻/PO₄²·⁻ surface species (H₂PO₄⁻ (catalyst surface)+·OH→H₂PO₄·(catalyst surface)+OH⁻; HPO₄²⁻ (catalyst surface)+·OH→HPO₄·⁻ (catalyst surface)+OH⁻; PO₄³⁻ (catalyst surface)+·OH→PO₄²·⁻ (catalyst surface)+OH⁻) based on the radical transfer mechanism, or in the case of R600-S, the conversion of aqueous ·OH into SO₄·⁻ surface species (SO₄²⁻ (catalyst surface)+·OH→SO₄·⁻ (catalyst surface)+OH⁻) based on the radical transfer mechanism; and 4) the conversion of aqueous ·OH into aqueous NO₃·(·OH+NO₃⁻ (aq)→OH⁻+NO₃·(aq) or ·OH+HNO₃ (aq)→H₂O+NO₃·(aq)) based on the radical transfer mechanism. Importantly, the conversion values of acetaminophen in Examples 9 to 13 vary depending on the type of catalyst applied, which means that the efficiency of the organic substance decomposition system of the present disclosure significantly depends on the type of catalyst applied, and that a preferred choice of a catalyst depending on the type of organic substance is important. Also importantly, the conversion values of acetaminophen in Examples 9 to 13 are significantly greater than the conversion values of acetaminophen in Comparative Example 2, which means that anodic oxidation, aqueous ·OH, NO₃·surface species, H₂PO₄·/HPO₄·⁻/PO₄²·⁻ surface species or SO₄·⁻ surface species, and aqueous NO³·comprehensively contribute to the decomposition of acetaminophen in Examples 9 to 13, and demonstrates the superiority of the organic substance decomposition system under electrical conditions proposed in the present disclosure.

### Experimental Example 6: Acetaminophen Decomposition System I Under Non-Electrical Conditions

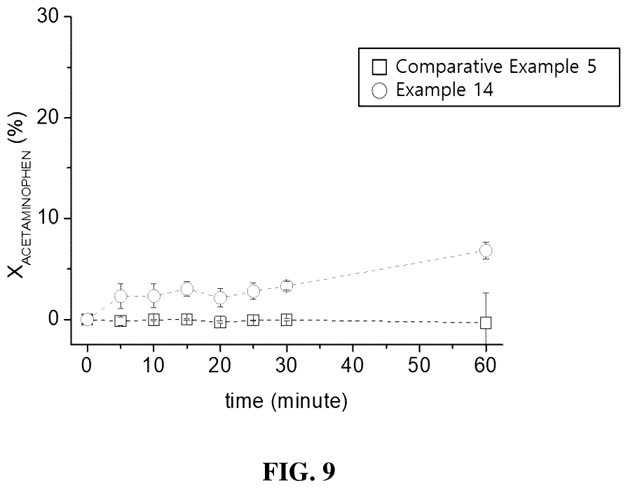

For the decomposition of 0.1 mmol of acetaminophen in 100 mL of an acidic aqueous solution containing 29.2 mmol of nitric acid and 0.14 mmol of Na₂SO₄, 0.2 g of ZrO₂ was used as a catalyst in the presence of 30 mmol of hydrogen peroxide. Under these conditions, the reaction for acetaminophen decomposition was performed at 25° C. and pH 1 for 60 minutes, and this was named Example 14. In addition, the reaction for acetaminophen decomposition was performed for 60 minutes (pH 1) under the same conditions as in Example 14 in the absence of 0.2 g of ZrO₂, and this was named Comparative Example 5. The results (conversion of acetaminophen (X_{ACETAMINOPHEN}) versus time of Example 14 and Comparative Example 5 are shown in FIG. 9. The amount of Zr leached into the aqueous solution in Example 14 was measured to be 10⁻³ mol %, which means that the decomposition of acetaminophen by aqueous ·OH produced as a result of the homolysis of H₂O₂ by the Brønsted acid active species (—OH) and Lewis acid active species (Zr4+) leached from the ZrO₂ catalyst surface is negligible. The conversion values of acetaminophen in Comparative Example 5 are 0%, which means that the conversion of acetaminophen due to the self-dissection reaction of hydrogen peroxide (generation of aqueous ·OH/·OOH/O₂·⁻) is negligibly small. In contrast, the conversion values of acetaminophen in Example 14 are attributable to the homolysis of H₂O₂ (generation of aqueous ·OH) by the Brønsted acid active species (—OH) and Lewis acid active species (Zr⁴⁺) existing on the ZrO₂ catalyst surface, and the conversion of aqueous ·OH to aqueous NO³·(·OH+NO₃⁻ (aq)→OH⁻+NO₃·(aq) or ·OH+HNO₃ (aq)→H₂O+NO₃·(aq)) based on the radical transfer mechanism. The conversion values of acetaminophen in Example 14 were observed to be 2 to 7%, which means that aqueous ·OH or aqueous NO³·dominates the decomposition of acetaminophen, and demonstrates the superiority of the organic substance decomposition system under non-electrical conditions proposed in the present disclosure. In addition, the conversion values of acetaminophen in Example 14 are smaller than those of acetaminophen in Example 1 or Example 2, which means that the use of an appropriate concentration of hydrogen peroxide is very important for improving the aqueous ·OH productivity, the aqueous NO₃·productivity, and the efficiency of decomposition of acetaminophen.

### Experimental Example 7: Acetaminophen Decomposition System V Under Electrical Conditions

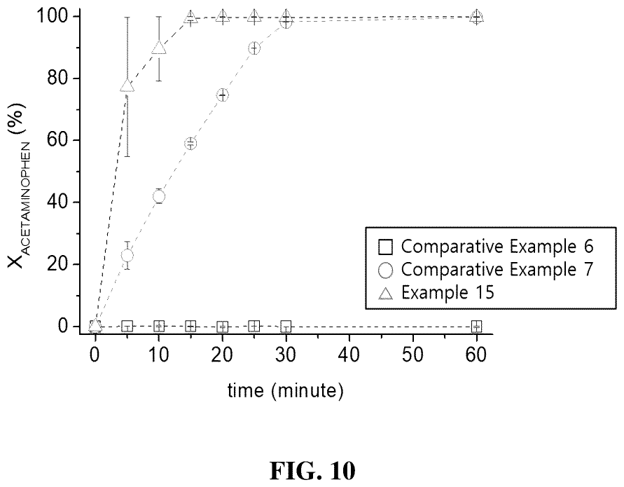

For the decomposition of 0.1 mmol of acetaminophen in 100 mL of an acidic aqueous solution containing 26.6 mmol of hydrochloric acid, 0.2 g of ZrO₂ was used as a catalyst, a graphite electrode was used as an electrode, and polyvinylidene fluoride (PVDF) was used as a binder for coating the electrode with the catalyst. Under these conditions, the reaction for acetaminophen decomposition was performed for 60 minutes at a voltage of 3 V, a power input of 2 W, 25° C. and pH 1, and this was named Example 15. In addition, acetaminophen adsorption was performed for 60 minutes under the same conditions as in Example 15 in the absence of the voltage of 3 V and the power of 2 W, and this was named Comparative Example 6. In addition, acetaminophen decomposition was performed for 60 minutes under the same conditions as Example 14 in the absence of 0.2 g of ZrO₂, and this was named Comparative Example 7. The results (conversion of acetaminophen (X_{ACETAMINOPHEN}) versus time) of Example 15 and Comparative Examples 6 and 7 are shown in FIG. 10. In the case of Comparative Example 6, the conversion of acetaminophen is 0%, which means that the amount of acetaminophen adsorbed on the ZrO₂ catalyst surface is negligibly small. In the case of Comparative Example 7, the conversion of acetaminophen is attributable to oxidation occurring at the anode (anodic oxidation). On the other hand, in the case of Example 15, the conversion of acetaminophen (X_{ACETAMINOPHEN}) can be attributed to the following four factors: 1) oxidation occurring at the anode (anodic oxidation); 2) homolysis of H₂O₂ (generation of aqueous ·OH) by the Brønsted acid active species (—OH) and Lewis acid active species (Zr⁴⁺) leached from the ZrO₂ catalyst surface; 3) the homolysis of H₂O₂ (generation of aqueous ·OH) by the Brønsted acid active species (—OH) and Lewis acid active species (Zr⁴⁺) existing on the ZrO₂ catalyst surface; and 4) conversion of aqueous ·OH to aqueous Cl·(·OH+Cl⁻ (aq)→OH⁻+Cl·(aq) or ·OH+HCl (aq)→H₂O+Cl·(aq)) based on the radical transfer mechanism. Importantly, the amount of Zr leached into the aqueous solution in Example 15 was measured to be 10⁻³ mol %, which means that the decomposition of acetaminophen by 2) above was negligible. Also importantly, the acetaminophen conversion values of Example 15 are significantly greater than those of Comparative Example 7, which means that anodic oxidation, aqueous ·OH, and aqueous Cl·contribute comprehensively to the decomposition of acetaminophen in Example 15, and demonstrates the superiority of the organic substance decomposition system under electrical conditions proposed in the present disclosure.

### Experimental Example 8: Acetaminophen Decomposition System V Under Electrical Conditions

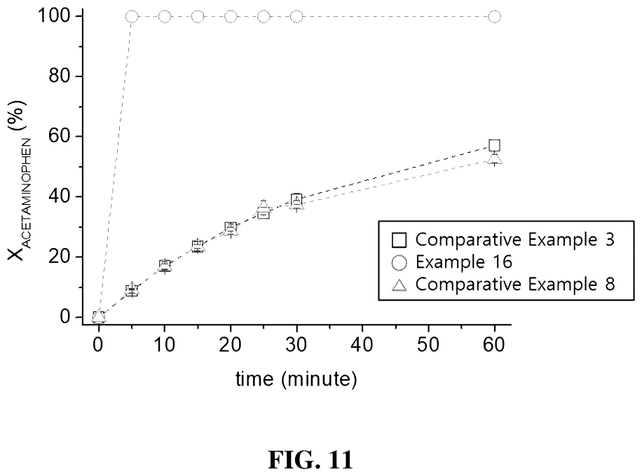

For the decomposition of 0.1 mmol of acetaminophen in 100 mL of an acidic aqueous solution containing 23.4 mmol of hydrochloric acid and 0.14 mmol of Na₂SO₄ (supporting electrolyte), 0.2 g of ZrO₂ was used as a catalyst, a graphite electrode was used as an electrode, and polyvinylidene fluoride (PVDF) was used as a binder for coating the electrolyte with the catalyst. Under these conditions, the reaction for acetaminophen decomposition was performed for 60 minutes at a voltage of 3 V, a power input of 2 W, 25° C. and pH 1, and this was named Example 16. In addition, the reaction for acetaminophen decomposition was performed for 60 minutes (pH 4.9) under the same conditions as in Example 16 in the absence of 23.4 mmol of hydrochloric acid, and this was named Comparative Example 3. In addition, the reaction for acetaminophen decomposition was performed for 60 minutes (pH 4.8) under the same conditions as in Example 15 in the absence of 23.4 mmol of hydrochloric acid and the presence of 23.4 mmol of Na₂SO₄, and this was named Comparative Example 8. The results (conversion of acetaminophen (X_{ACETAMINOPHEN}) versus time) of Example 16, Comparative Examples 3 and Comparative Examples 8 are shown in FIG. 11. Importantly, the amount of Zr leached into the aqueous solution in Example 16, Comparative Examples 3 and Comparative Examples 8 was measured to be 10⁻³ mol %, which means that the decomposition of acetaminophen by aqueous ·OH generated as a result of the homolysis of H₂O₂ by the Brønsted acid active species (—OH) and Lewis acid active species (Zr⁴⁺) leached from the ZrO₂ catalyst surface is negligible. In the case of Comparative Examples 3 and 8, the conversion values of acetaminophen were similar regardless of the change in the amount (0.14 mmol or 23.4 mmol) of Na₂SO₄ (supporting electrolyte), which means that the improvement in acetaminophen decomposition efficiency by the supporting electrolyte was negligibly small. Also importantly, the conversion values of acetaminophen in Comparative Examples 3 and 8 are attributable to oxidation occurring at the anode (anodic oxidation) and the homolysis of H₂O₂ by the Brønsted acid active species (—OH) and Lewis acid active species (Zr⁴⁺) existing on the ZrO₂ catalyst surface. In contrast, the conversion values of acetaminophen in Example 16 are attributable to 1) oxidation occurring at the anode (anodic oxidation), 2) the homolysis of H₂O₂ (generation of aqueous ·OH) by the Brønsted acid active species (—OH) and Lewis acid active species (Zr⁴⁺) existing on the ZrO₂ catalyst surface, and 3) the conversion of aqueous ·OH to aqueous Cl·(·OH+Cl⁻ (aq)→OH⁻+Cl·(aq) or ·OH+HCl (aq)→H₂O+Cl·(aq)) based on the radical transfer mechanism. The conversion values of acetaminophen in Example 16 were 100% after 5 minutes, which means that the aqueous Cl·in 3) above significantly enhances the acetaminophen decomposition efficiency, and demonstrates the superiority of the organic substance decomposition system under electrical conditions proposed in the present disclosure. In addition, the conversion values of acetaminophen in Example 16 are significantly greater than those of acetaminophen in Example 15, which means that the use of an appropriate concentration of the supporting electrolyte is significantly desirable for improving the aqueous Cl·productivity and the efficiency of decomposition of acetaminophen.

### Experimental Example 9: Acetaminophen Decomposition System VI Under Electrical Conditions

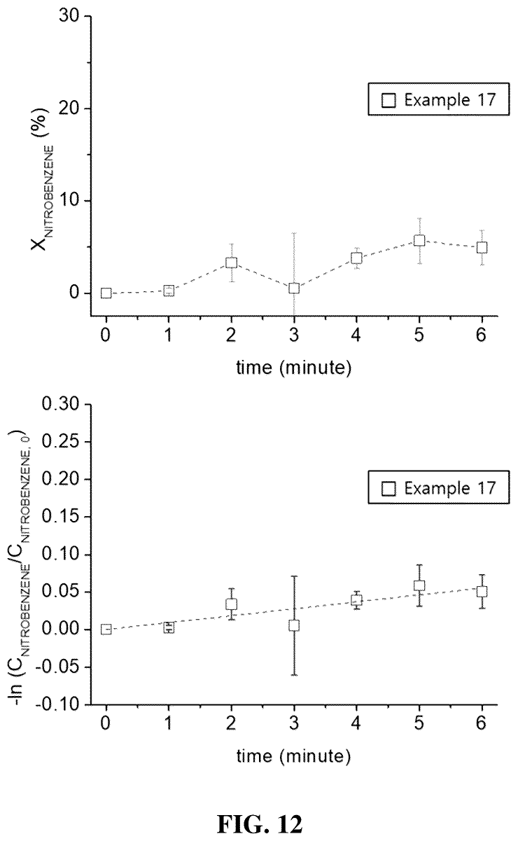

Nitrobenzene has negligibly low reactivity with aqueous Cl·(reaction rate constant ˜0 L mol⁻¹ sec⁻¹), and therefore, under the condition where aqueous Cl·functions as the major radical for organic substance decomposition, the performance of decomposition of nitrobenzene should be negligibly low. Thus, for the decomposition of 0.1 mmol of nitrobenzene in 100 mL of an acidic aqueous solution containing 26.6 mmol of hydrochloric acid, 0.2 g of ZrO₂ was used as a catalyst, a graphite electrode was used as an electrode, and polyvinylidene fluoride (PVDF) was used as a binder for coating the electrode with the catalyst, and under these conditions, the reaction for acetaminophen decomposition was performed for 60 minutes at a voltage of 3 V, a power input of 2 W, 25° C. and pH 1, and this was named Example 17. The conversion values of nitrobenzene in Example 17 were corrected using those of anodic oxidation, and the rate constant (k_{APP}, min⁻¹) of the reaction for decomposing nitrobenzene was determined using the slope of the pseudo-1^{st}-order kinetic fitting graph (−ln(C_{NITROBENZENE}/C_{NITROBENZENE, 0}) versus time) of FIG. 12 obtained using the conversion values of nitrobenzene (X_{NITROBENZENE}) versus time) obtained after correction. In the case of Example 17, the conversion of nitrobenzene and the rate constant of the reaction can be attributed to the following four factors: 1) oxidation occurring at the anode (anodic oxidation); 2) the homolysis of H₂O₂ (generation of aqueous ·OH) by the Brønsted acid active species (—OH) and Lewis acid active species (Zr⁴⁺) leached from the ZrO₂ catalyst surface; 3) the homolysis of H₂O₂ (generation of aqueous ·OH) by the Brønsted acid active species (—OH) and Lewis acid active species (Zr⁴⁺) existing on the ZrO₂ catalyst surface; and 4) the conversion of aqueous ·OH to aqueous Cl·(·OH+Cl⁻ (aq)→OH⁻+Cl·(aq) or ·OH+HCl (aq)→H₂O+Cl·(aq)) based on the radical transfer mechanism. Importantly, the amount of Zr leached into the aqueous solution in Example 17 was measured to be 10⁻³ mol %, which means that the decomposition of nitrobenzene 0 by 2) above was negligible. Also importantly, although anodic oxidation, aqueous ·OH, and aqueous Cl·comprehensively contributed to the conversion of nitrobenzene in Example 17, the conversion values of nitrobenzene were 6% or less and the reaction rate constant was very small (9×10⁻³ min⁻¹). This means that, in the system proposed in the present disclosure, aqueous Cl·can function as a major radical for the decomposition of organic substances (e.g., acetaminophen) other than nitrobenzene, which is consistent with the result of Experimental Example 8 indicating that aqueous Cl' significantly promotes the efficiency of decomposition of acetaminophen.

### Experimental Example 10: Electron Paramagnetic Resonance Spectroscopy Analysis

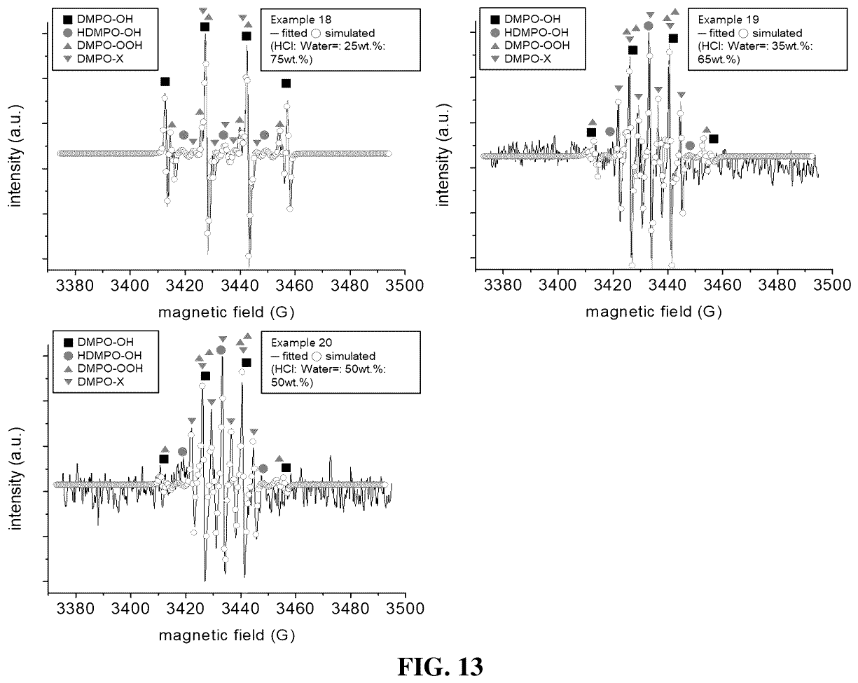

To investigate the radical productivity of the ZrO₂ catalyst dispersed in hydrochloric acid solution in the presence of hydrogen peroxide, such as aqueous ·OH/·OOH/O₂·⁻ productivity and aqueous Cl·productivity, 0.1 g of ZrO₂ and 0.08 g of 5,5-dimethyl-1-pyrroline N-oxide (DMPO), a spin-trapping agent for radicals, were added to 0.14 mL of distilled water and stirred for 3 minutes. The reaction solution was then collected using a filter, and liquid electron paramagnetic resonance (EPR) spectroscopy analysis was performed at room temperature. Here, the concentration of hydrochloric acid added to the distilled water was adjusted to 25 wt % (Example 18), 35 wt % (Example 19), and 50 wt % (Example 20), and the pH of the aqueous solution was less than 2. Hydrogen peroxide reacts with the Brønsted acid active species and Lewis acid active species of the ZrO₂ catalyst to produce aqueous ·OH/·OOH/O₂·⁻, and the produced radicals are trapped by DMPO to form DMPO-OH (·OH; black squares) and DMPO-OOH (·OOH/O₂·⁻; green triangles) products. In addition, the DMPO-OH is oxidized to form HDMPO, and aqueous ·OH is additionally trapped by some of the HDMPO to form an HDMPO-OH (red circle) product, or aqueous Cl·is trapped by DMPO-OH or DMPO-OOH and then reacts with aqueous OH⁻ to form a DMPO-X (blue inverted triangle) product. Since the above-described DMPO-based products contain radicals, they may be monitored in the form of signals during EPR spectroscopy analysis and used to analyze the concentration of radicals present in the reaction solution. As shown in FIG. 13 and Table 5 below, as the concentration of HCl increases from 25 wt %→35 wt %→50 wt %, the concentration of DMPO-OH or DMPO-OOH decreases (DMPO-OH (40.0%→17.2%); DMPO-OOH (28.0%→10.3%)) and the concentration of DMPO-X increases (20.0%→69.1%). This is because as the concentration of hydrochloric acid in the reaction solution increases, the equilibrium of ·OH+Cl⁻ (aq)↔OH⁻+Cl·(aq) or ·OH+HCl (aq)↔H₂O+Cl·(aq) shifts to the right, thus increasing the concentration of aqueous Cl·. Importantly, this means that as the pH of the organic substance decomposition system proposed in the present disclosure decreases, the concentration of the aqueous Cl·, which is mainly used for the decomposition of recalcitrant/toxic organic substances, may increase.

TABLE 5

| | Concentration (%) | | | |
|---|---|---|---|---|
| | DMPO-OH | HDMPO-OH | DMPO-OOH | DMPO-X |
| 25 wt % HCl | 40.0 | 12.0 | 28.0 | 20.0 |
| 35 wt % HCl | 23.8 | 4.8 | 23.8 | 47.6 |
| 50 wt % HCl | 17.2 | 3.4 | 10.3 | 69.1 |

### Experimental Example 11: Acetaminophen Decomposition System VII Under Electrical Conditions

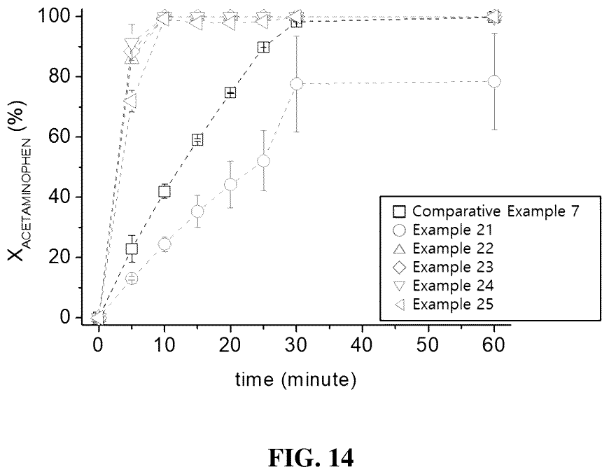

For the decomposition of 0.1 mmol of acetaminophen in 100 mL of an acidic aqueous solution containing 26.6 mmol of hydrochloric acid, 0.2 g of O300 was used as a catalyst in Example 21, 0.2 g of R600 was used as a catalyst in Example 22, 0.2 g of R600-N was used as a catalyst in Example 23, 0.2 g of R600-P was used as a catalyst in Example 24, 0.2 g of R600-S was used as a catalyst in Example 25, a graphite electrode was used as an electrode, and polyvinylidene fluoride (PVDF) was used as a binder for coating the electrode with the catalyst. Under these conditions, the reaction for acetaminophen decomposition was performed for 60 minutes at a voltage of 3 V, a power input of 2 W, 25° C. and pH 1, and these examples were named Examples 21 to 25. In addition, acetaminophen decomposition was performed for 60 minutes under the same conditions as in Examples 21 to 25 in the absence of 0.2 g of the catalyst, and this was named Comparative Example 7. The results (conversion of acetaminophen (X_{ACETAMINOPHEN}) versus time) of Examples 21 to 25 and Comparative Example 7 are shown in FIG. 14. The amount of Ti leached into the aqueous solution in Examples 21 to 25 was measured to be 10⁻³ mol %, which means that the decomposition of acetaminophen by aqueous ·OH formed as a result of the homolysis of H₂O₂ by the Brønsted acid active species (—OH) and Lewis acid active species (Ti⁴⁺) leached from the surface of the O300, R600, R600-N, R600-P or R600-S catalyst is negligible. In the case of Comparative Example 7, the conversion of acetaminophen is attributable to oxidation occurring at the anode (anodic oxidation). On the other hand, in the case of Examples 21 to 25, the conversion of acetaminophen (X_{ACETAMINOPHEN}) can be attributed to the following four factors: 1) oxidation occurring at the anode (anodic oxidation); 2) the homolysis of H₂O₂ (generation of aqueous ·OH) by the Brønsted acid active species (—OH) and Lewis acid active species (Ti⁴⁺) existing on the surface of the O300, R600, R600-N, R600-P or R600-S catalyst; 3) in the case of R600-N, the conversion of aqueous ·OH to NO₃·surface species (NO₃⁻ (catalyst surface)+·OH→NO₃·(catalyst surface)+OH⁻) based on the radical transfer mechanism, or in the case of R600-P, the conversion of aqueous ·OH to H₂PO₄·/HPO₄·⁻/PO₄²·⁻ surface species (H₂PO₄⁻ (catalyst surface)+·OH→H₂PO₄·(catalyst surface)+OH⁻; HPO₄²·⁻ (catalyst surface)+·OH→HPO₄·⁻ (catalyst surface)+OH⁻; PO₄³⁻ (catalyst surface)+·OH→PO₄²·⁻ (catalyst surface)+OH⁻) based on the radical transfer mechanism, or in the case of R600-S, the conversion of aqueous ·OH to SO₄·⁻ surface species (SO₄²⁻ (catalyst surface)+·OH→SO₄·⁻ (catalyst surface)+OH⁻) based on the radical transfer mechanism; and 4) the conversion of aqueous ·OH to aqueous Cl·(·OH+Cl⁻ (aq)→OH⁻+Cl·(aq) or ·OH+H Cl (aq)→H₂O+Cl·(aq)) based on the radical transfer mechanism. Importantly, the conversion values of acetaminophen in Examples 21 to 25 vary depending on the type of catalyst applied, which means that the efficiency of the organic substance decomposition system of the present disclosure significantly depends on the type of catalyst applied, and that a preferred choice of a catalyst depending on the type of organic substance is important. Also importantly, the conversion values of acetaminophen in Examples 22 to 25 are significantly greater than the conversion values of acetaminophen in Comparative Example 7, which means that anodic oxidation, aqueous ·OH, NO₃·surface species, H₂PO₄·/HPO₄·⁻/PO₄²·⁻ surface species or SO4·⁻ surface species and aqueous Cl·comprehensively contribute to the decomposition of acetaminophen in Examples 22 to 25, and demonstrates the superiority of the organic substance decomposition system under electrical conditions proposed in the present disclosure.

### Experimental Example 12: Acetaminophen Decomposition System II Under Non-Electrical Conditions

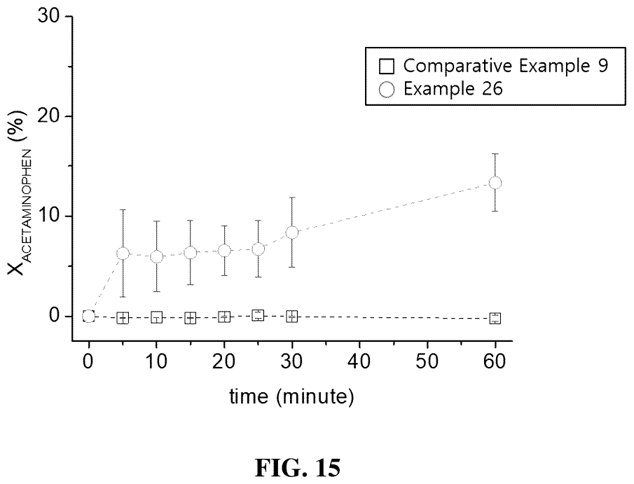

For the decomposition of 0.1 mmol of acetaminophen in 100 mL of an acidic aqueous solution containing 23.4 mmol of hydrochloric acid and 0.14 mmol of Na₂SO₄, 0.2 g of ZrO₂ was used as a catalyst in the presence of 30 mmol of hydrogen peroxide, and under these conditions, the reaction for acetaminophen decomposition was performed for 60 minutes at 25° C. and pH 1, and this was named Example 26. In addition, the reaction for acetaminophen decomposition was performed for 60 minutes (pH 1) under the same conditions as in Example 26 under the absence of 0.2 g of ZrO₂, and this was named Comparative Example 9. The results (conversion of acetaminophen (X_{ACETAMINOPHEN}) versus time of Example 26 and Comparative Example 9 are shown in FIG. 15. The amount of Zr leached into the aqueous solution in Example 26 was measured to be 10⁻³ mol %, which means that the decomposition of acetaminophen by aqueous ·OH produced as a result of the homolysis of H₂O₂ by the Brønsted acid active species (—OH) and Lewis acid active species (Zr⁴⁺) leached from the ZrO₂ catalyst surface is negligible. The conversion values of acetaminophen in Comparative Example 9 are 0%, which means that the conversion of acetaminophen due to the self-dissection reaction of hydrogen peroxide (generation of aqueous ·OH/·OOH/O₂·⁻) is negligibly small. In contrast, the conversion values of acetaminophen in Example 26 are attributable to 1) the homolysis of H₂O₂ (generation of aqueous ·OH) by the Brønsted acid active species (—OH) and Lewis acid active species (Zr⁴⁺) existing on the ZrO₂ catalyst surface, and 2) the conversion of aqueous ·OH to aqueous Cl·(·OH+Cl⁻ (aq)→OH⁻+Cl·(aq) or ·OH+HCl (aq)→H₂O+Cl·(aq)) based on the radical transfer mechanism. The conversion values of acetaminophen in Example 26 were observed to be 5 to 15%, which means that aqueous ·OH or aqueous Cl·dominates the decomposition of acetaminophen, and demonstrates the superiority of the organic substance decomposition system under non-electrical conditions proposed in the present disclosure. In addition, the conversion values of acetaminophen in Example 26 are smaller than those of acetaminophen in Example 15 or Example 16, which means that the use of an appropriate concentration of hydrogen peroxide is very important for improving the aqueous ·OH productivity, the aqueous Cl·productivity, and the efficiency of decomposition of acetaminophen.

The above description of the present disclosure is exemplary, and those of ordinary skill in the art will appreciate that the present disclosure can be easily modified into other specific forms without departing from the technical spirit or essential characteristics of the present disclosure. Therefore, it should be understood that the exemplary embodiments described above are exemplary in all aspects and are not restrictive. For example, each component described to be of a single type can be implemented in a distributed manner. Likewise, components described to be distributed can be implemented in a combined manner.

The scope of the present disclosure is defined by the appended claims, and it shall be understood that all modifications and embodiments conceived from the meaning and scope of the claims and their equivalents are included in the scope of the present disclosure.

What is claimed is:

1. A catalyst for an organic substance decomposition system, comprising catalyst particles comprising a non-reducible transition metal oxide.

2. The catalyst of claim 1, wherein at least a portion of a surface of the non-reducible transition metal oxide is a reduced surface.

3. The catalyst of claim 1, wherein at least a portion of a surface of the non-reducible transition metal oxide comprises a functional group.

4. The catalyst of claim 3, wherein the functional group comprises at least one selected from the group consisting of a nitrate group, a phosphate group, a sulfate group, and combinations thereof.

5. The catalyst of claim 4, wherein the nitrate group comprises NO₃⁻, the phosphate group comprises at least one selected from the group consisting of H₂PO₄⁻, HPO₄²⁻, PO₄³⁻, and combinations thereof, and the sulfate group comprises SO₄²⁻.

6. The catalyst of claim 1, wherein the non-reducible transition metal oxide comprises at least one selected from the group consisting of TiO₂, ZrO₂, HfO₂, Nb₂O₅, Ta₂O₅, and combinations thereof.

7. The catalyst of claim 1, wherein the catalyst has a porous structure.

8. The catalyst of claim 1, wherein the catalyst has a diameter of 0.1 nm to 500 μm.

9. A method for producing a catalyst for an organic substance decomposition system, comprising a production step of producing catalyst particles comprising a non-reducible transition metal oxide.

10. The method of claim 9, further comprising a reduction step of reducing at least a portion of a surface of the catalyst particles by treatment with hydrogen.

11. The method of claim 9, further comprising a functionalization step of attaching a functional group to at least a portion of a surface of the catalyst particles.

12. An electrode for an organic substance decomposition system, comprising:
the catalyst according to claim 1;
a support on which the catalyst is supported;
a substrate coated with the support; and
a binder interposed between the support and the substrate.

13. The electrode of claim 12, wherein the catalyst is in powder form.

14. The electrode of claim 12, wherein the catalyst is comprised in an amount of 0.01 to 50 parts by weight based on 100 parts by weight of the support.

15. The electrode of claim 12, wherein the support comprises at least one selected from the group consisting of carbon (C), Al₂O₃, MgO, ZrO₂, CeO₂, SiO₂, and combinations thereof.

16. The electrode of claim 12, wherein the binder is an insoluble polymer.

17. An organic substance decomposition system comprising:
the electrode according to claim 12; and
an aqueous electrolyte solution containing at least one acid selected from the group consisting of nitric acid (HNO₃), phosphoric acid (H₃PO₄), sulfuric acid (H₂SO₄), hydrochloric acid (HCl), and combinations thereof.

18. The organic substance decomposition system of claim 17, wherein the aqueous electrolyte solution contains a supporting electrolyte, wherein a concentration of the supporting electrolyte is 10⁻⁵ mol L⁻¹ to 10⁵ mol L⁻¹.

19. The organic substance decomposition system of claim 17, wherein the aqueous electrolyte solution has a pH of less than 2.

20. The organic substance decomposition system of claim 17, wherein the system is used in a process of decomposing organic substances under electrical or non-electrical conditions.

21. A method for decomposing organic substances using the organic substance decomposition system according to claim 17, the method comprising:
a step in which aqueous ·OH species is formed by homolysis of H₂O₂;
a step in which functionalized NO₃⁻ surface species, H₂PO₄⁻/HPO₄²⁻/PO₄³⁻ surface species or SO₄²⁻ surface species is converted to NO₃·surface species, H₂PO₄·/HPO₄·⁻/PO₄²·⁻ surface species or SO₄·⁻ surface species by the aqueous ·OH species;
a step in which aqueous NO₃⁻, aqueous PO₄³⁻, aqueous SO₄²⁻ or aqueous Cl⁻ is converted to aqueous NO₃·, aqueous H₂PO₄·/HPO₄·⁻/PO₄²·⁻, aqueous SO₄·⁻ or aqueous Cl·by the aqueous ·OH species; and
a step in which recalcitrant/toxic organic substances are decomposed by at least one radical species among the aqueous ·OH, the NO₃·surface species, the H₂PO₄·/HPO₄·⁻/PO₄²·⁻ surface species, the SO₄·⁻ surface species, the aqueous NO₃·, the aqueous H₂PO₄·/HPO₄·⁻/PO₄²·⁻, the aqueous SO₄·⁻ and the aqueous Cl·.
